(19) United States
(12) Patent Application Publication
(10) Pub. No.: US 2022/0202218 A1
(43) Pub. Date: Jun. 30, 2022

(54) BIO-DEGRADABLE FOOD HANDLING DEVICES AND SYSTEMS AND METHODS FOR MAKING THE DEVICES

(71) Applicants: Jobin JOSE, Bangalore (IN); Saji VARGHESE, Bangalore (IN)

(72) Inventors: Saji VARGHESE, Bangalore (IN); Jobin JOSE, Bangalore (IN)

(21) Appl. No.: 17/606,019

(22) PCT Filed: Apr. 22, 2020
(86) PCT No.: PCT/IN2020/050376

§ 371 Date: Oct. 23, 2021

(30) Foreign Application Priority Data
Apr. 24, 2019 (IN) 201941016219

(51) Int. Cl. A47G 21/00; A47G 21/18; A47G 21/06

(52) U.S. Cl. CPC A47G 21/001; A47G 21/103; A47G 21/18

(57) ABSTRACT

Bio-degradable food handling devices and systems and methods for making the devices. The embodiments herein relate to a bio-degradable food handling device (10, 20, 30, 40, 50 and 60) for use as at least one of a drinking straw, a stirrer, a chopstick, a balloon stick and a candy stick. Further, embodiments herein relate to systems (100) and methods (200, 300) of making the bio-degradable food handling devices (10, 20, 30, 40, 50 and 60). The bio-degradable food handling device (10) is hydrophobic and antifungal thereby increasing shelf life of bio-degradable food handling devices (10). The bio-degradable food handling device (10) is durable, hygienic, non-toxic and recyclable. The bio-degradable food handling device (10) has smooth and soft outer portion that provides comfort to user. The bio-degradable food handling device (10) can be used to draw pieces of fruit, vegetables, solid processed food pieces and other pieces of foods therethrough.

### CROSS REFERENCE TO RELATED APPLICATION

This application is based on and derives the benefit of Indian Application 201941016219 filed on 24 Apr. 2019, the contents of which are incorporated herein by reference.

### TECHNICAL FIELD

The embodiments herein relate to a bio-degradable food handling device for use as at least one of a drinking straw, a stirrer, a chopstick, a balloon stick and a candy stick. Further, embodiments herein relate to systems and methods of making the bio-degradable food handling devices.

### BACKGROUND

Generally, a drinking straw is an elongated tube that allows a user to draw fluid from tender coconuts, fluid containers and the like to consume drinkables therefrom. Mostly, drinking straws are made of plastic. Though the manufacturing of plastic straws incurs less cost, plastic straws account for a significant amount of un-recycled plastic waste and contribute to plastic pollution in the ocean. Some drinking straws are made of paper. Though paper straws are bio-degradable, the manufacturing of paper straws incurs high cost. In some cases, drinking straws are made of single layer of leaf strip which is rolled longitudinally and the glue is applied along a longitudinal portion of the leaf strip to join the longitudinal portion with corresponding portion of the leaf strip to maintain the leaf strip in the rolled position. Though, such drinking straws are bio-degradable, the joining of longitudinal portion of the leaf strip with corresponding portion of the leaf strip would result in glue being spread onto an inner portion and/or an outer portion of the straw and the glue may come in direct contact with the drinkable which is undesirable. Further, the inner portion of the single layered bio-degradable straw is an abaxial portion of the leaf which has negligible wax on it and the inner portion of the straw is prone to fungal attack under humid conditions which is harmful to the user and also reduces the shelf life of the straws. Furthermore, the inner portion of the straw which is the abaxial portion of the leaf is home to several insects and spiders and is also subjected to accumulation of dirt and other foreign particles and the chances of such leaf not getting completely cleaned is very high thereby posing hygiene issues in the straws.

Further, a coffee stirrer is an elongated metallic rod that is used to stir the coffee in a mug or any other vessel. Though the metallic coffee stirrer is durable, the manufacturing of metallic coffee stirrer incurs high cost. Furthermore, chop stick are a pair of equal length sticks that are used as kitchen and eating utensils. Mostly chop sticks are made of bamboo and wood. Though bamboo and wood chop sticks are bio-degradable, relatively inexpensive and low in temperature conduction and provide good grip for holding food, the bamboo and wood chop sticks can warp and deteriorate with continued use.

Similarly, balloon sticks and candy sticks are made of plastic. Though the manufacturing of plastic balloon and candy sticks incurs less cost, plastic balloon and candy sticks account for a significant amount of un-recycled plastic waste.

Further, the process of making each of plastic straw, the stirrer, the chopstick, the balloon stick and the candy sticks may vary and separate set of machines are required for making each of the plastic straw, the stirrer, the chopstick, the balloon stick and the candy sticks which in turn incurs high costs.

Therefore, there exists a need for a bio-degradable food handling device, which obviates the aforementioned drawbacks. Further, there exists a need for systems and methods for making the bio-degradable food handling devices, which obviates the aforementioned drawbacks.

### OBJECTS

The principal object of embodiments herein is to provide bio-degradable food handling devices.

Another object of embodiments herein is to provide a system for making a multi-layered bio-degradable food handling device.

Another object of embodiments herein is to provide a method for making a multi-layered bio-degradable food handling device.

Another object of embodiments herein is to provide a system for making a single layered bio-degradable food handling device.

Another object of embodiments herein is to provide a method for making a single-layered bio-degradable food handling device.

Another object of embodiments herein is to provide multi-layered bio-degradable food handling devices, which is made from at least one of a plant leaf and tree leaf such as but not limited to a coconut tree leaf.

Another object of embodiments herein is to provide multilayered bio-degradable food handling devices, which is hydrophobic in which an inner portion and an outer portion of the bio-degradable food handling device is an adaxial portion of the plant leaf or tree leaf.

A further object of embodiments herein is to provide a bio-degradable food handling device for use as a drinking straw.

Yet another object of embodiments herein is to provide a bio-degradable food handling device for use as at least one of a stirrer, a chopstick, a balloon stick and a candy stick.

Another object of embodiments herein is to provide a bio-degradable food handling device for use in a tetra pack.

Another object of embodiments herein is to provide multilayered bio-degradable food handling devices, which is anti-fungal thereby increasing the shelf life of the multilayered bio-degradable food handling device in which an inner portion and an outer portion of the bio-degradable food handling device is an adaxial portion of the plant leaf or tree leaf.

Another object of embodiments herein is to provide bio-degradable food handling devices, which is non-toxic and recyclable.

Another object of embodiments herein is to provide bio-degradable food handling devices, which is durable, hygienic and incurs less cost.

Another object of embodiments herein is to provide a bio-degradable food handling device for use as a drinking straw which can be used to sip warm or hot liquids.

Another object of embodiments herein is to provide a bio-degradable food handling device, which has smooth and soft outer portion that provides comfort to the user.

Another object of embodiments herein is to provide a bio-degradable food handling device for use as a drinking straw which can be used to draw pieces of fruit, vegetables, solid processed food pieces and other pieces of foods therethrough.

Another object of embodiments herein is to provide a bio-degradable food handling device, which is durable and has larger diameter and has a piercing portion which is efficient to pierce seals of any of tumblers, cans, tetra pack and any other food storage pack from which liquids/beverages with or without pieces of any of fruit, vegetables, solid processed food pieces and other pieces of foods can be drawn therethrough.

These and other objects of embodiments herein will be better appreciated and understood when considered in conjunction with following description and accompanying drawings. It should be understood, however, that the following descriptions, while indicating embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF DRAWINGS

The embodiments are illustrated in the accompanying drawings, throughout which like reference letters indicate corresponding parts in various figures. The embodiments herein will be better understood from the following description with reference to the drawings, in which:

FIG. 1a and FIG. 1b depict a front view and a rear view of a main leaf strip respectively, according to a first embodiment as disclosed herein;

FIG. 1c and FIG. 1d depict a front view and a rear view of an add-on leaf strip respectively, according to the first embodiment as disclosed herein;

FIG. 1e and FIG. 1f depict a front view and a bottom view of another add-on leaf strip respectively, according to the first embodiment as disclosed herein;

FIG. 2a depicts a perspective view of a bio-degradable food handling device, where the main leaf strip is spiral rolled onto an elongated fixture member and a plurality of add-on leaf strips is in an exploded view condition, according to the first embodiment as disclosed herein;

FIG. 2b depicts another perspective view of the bio-degradable food handling device, where the add-on leaf strips are attached onto the main leaf strip which is spiral rolled onto the elongated support member, according to the first embodiment as disclosed herein;

FIG. 2c depicts another perspective view of the bio-degradable food handling device, where the bio-degradable food handling device is removed from the elongated fixture member, according to the first embodiment as disclosed herein;

FIG. 3a and FIG. 3b depict a front view and a rear view of a main leaf strip, according to a second embodiment as disclosed herein;

FIG. 3c and FIG. 3d depict a front view and rear view of an add-on leaf strip, according to the second embodiment as disclosed herein;

FIG. 4a depicts a perspective view of a bio-degradable food handling device, where a main leaf strip is in a spiral rolled onto an elongated fixture member and an add-on leaf strip is in an exploded view condition, according to the second embodiment as disclosed herein;

FIG. 4b depicts another perspective view of the bio-degradable food handling device, where the add-on leaf strip is attached onto the main leaf strip which is spiral rolled onto the elongated fixture member, according to the second embodiment as disclosed herein;

FIG. 4c depicts another perspective view of the bio-degradable food handling device, where the bio-degradable food handling device is removed from the elongated fixture member, according to the second embodiment as disclosed herein;

FIG. 5a and FIG. 5b depict a front view and a rearview of a main leaf strip, according to a third embodiment as disclosed herein;

FIG. 5c and FIG. 5d depict a front view and rear view of an add-on leaf strip, according to the third embodiment as disclosed herein;

FIG. 6a depicts a perspective view of a bio-degradable food handling device, where a main leaf strip is in a spiral rolled onto an elongated fixture member and an add-on leaf section is in an exploded view condition, according to the third embodiment as disclosed herein;

FIG. 6b depicts another perspective view of the bio-degradable food handling device, where the add-on leaf section is attached onto the main leaf strip which is spiral rolled onto the elongated fixture member, according to the third embodiment as disclosed herein;

FIG. 6c depicts another perspective view of the bio-degradable food handling device, where a plurality of add-on leaf strips is in an exploded view condition, according to the third embodiment as disclosed herein;

FIG. 6d depicts another perspective view of the bio-degradable food handling device, where the add-on leaf strips is attached onto the add-on leaf section and the spiral rolled main leaf strip, according to the third embodiment as disclosed herein;

FIG. 6e depicts another perspective view of the bio-degradable food handling device, where the bio-degradable food handling device is removed from the elongated fixture member, according to the third embodiment as disclosed herein;

FIG. 7a depicts a perspective view of a first leaf strip which is spiral rolled on an elongated fixture member, according a fourth embodiment as disclosed herein;

FIG. 7b depicts a perspective view of a second leaf strip which is spiral rolled the spiral rolled first leaf strip, according a fourth embodiment as disclosed herein;

FIG. 7c depicts a perspective view of a bio-degradable food handling device, where the bio-degradable food handling device is removed from the elongated fixture member, according to the fourth embodiment as disclosed herein;

FIG. 8a and FIG. 8b depict a front view and a rearview of a first leaf strip, according to a fifth embodiment as disclosed herein;

FIG. 8c and FIG. 8d depict a front view and a rear view of a second leaf strip, according to the fifth embodiment as disclosed herein;

FIG. 9a depict a perspective view of the first leaf strip overlapped onto the second leaf strip, according to the fifth embodiment as disclosed herein;

FIG. 9b depicts a perspective view the overlapped first and second leaf strip which is spirally rolled onto an elongated fixture member, according to the fifth embodiment as disclosed herein;

FIG. 9c depicts a perspective view of a bio-degradable food handling device, where the bio-degradable food handling device is removed from the elongated fixture member, according to the fifth embodiment as disclosed herein;

FIG. 10a and FIG. 10b depict a front view and a rearview of a leaf strip, according to a sixth embodiment as disclosed herein;

FIG. 10c depicts a perspective view of the leaf strip which is spiral rolled on the elongated fixture member, according to the sixth embodiment as disclosed herein;

FIG. 10d depicts a perspective view of a bio-degradable food handling device, where the bio-degradable food handling device is removed from the elongated fixture member, according to the sixth embodiment as disclosed herein;

FIG. 11 depicts a schematic view of a system for making a multilayered bio-degradable food handling device, according to embodiments as disclosed herein;

FIGS. 12a and 12b depict perspective views of a leaf strip width cutting system, according to embodiments as disclosed herein;

FIG. 13 depicts a perspective view of a leaf strip scraping system, according to embodiments as disclosed herein;

FIG. 14 depicts a perspective view of a leaf strip spiral rolling system, according to embodiments as disclosed herein;

FIG. 15 depicts a perspective view of an add-on leaf strip attaching system, according to embodiments as disclosed herein;

FIG. 16 depicts a flowchart indicating a method for making a multi-layered bio-degradable food handling device, according to embodiments as disclosed herein; and

FIG. 17 depicts a flowchart indicating a method for making a single-layered bio-degradable food handling device, according to embodiments as disclosed herein.

### DETAILED DESCRIPTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

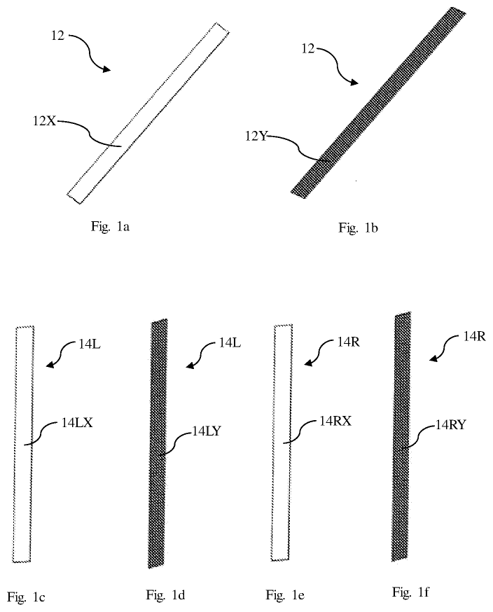

The embodiments herein achieve bio-degradable food handling devices. Further, embodiments herein achieve systems and methods for making the bio-degradable food handling devices. Further, embodiments herein achieve bio-degradable food handling devices for use as at least one of a drinking straw, a stirrer, a chopstick, a balloon stick and a candy stick. Referring now to the drawings FIGS. 1 through 17, where similar reference characters denote corresponding features consistently throughout the figures, there are shown embodiments.

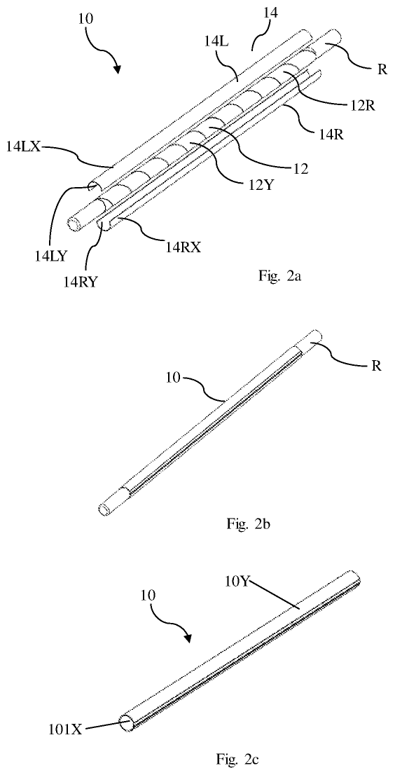

FIG. 2a depicts a perspective view of a bio-degradable food handling device (10), where a main leaf strip (12) is spiral rolled onto an elongated fixture member (R) and a plurality of add-on leaf strips (14L, 14R) is in an exploded view condition, according to a first embodiment as disclosed herein. For the purpose of this description and ease of understanding, the bio-degradable food handling device (10) is explained herein with below reference to be used as at least one of a drinking straw, a stirrer, a chopstick, a balloon stick and a candy stick. However, it is also within the scope of the invention to use the bio-degradable food handling device (10) for handling any other types of eatables, dairy based foods and any other types of food without otherwise deterring the intended function of the bio-degradable food handling device (10) as can be deduced from the description and corresponding drawings.

The main leaf strip (12) defines an adaxial portion (12X), as shown in FIG. 1a) and an abaxial portion (12Y), as shown in FIG. 1b). The main leaf strip (12) is adapted to be rolled on an elongated fixture member (R), as shown in FIG. 2a) to facilitate formation of an elongated rolled member (12R). For the purpose of this description and ease of understanding, the elongated fixture member (R) is considered to be rod or a tube.

The add-on leaf strip assembly (14) is adapted to be attached to the elongated rolled member (12R) thereby facilitating formation of the bio-degradable food handling device (10), as shown in FIG. 2b). The add-on leaf strip assembly (14) includes a plurality of add-on leaf strips (14L, 14R), as shown in FIG. 2a), where each add-on leaf strip (14L, 14R) defines an adaxial portion (14LX, 14RX), as shown in FIG. 1c and FIG. 1e) and an abaxial portion (14LY, 14RY), as shown in FIG. 1d and FIG. 1f). The main leaf strip (12) and each add-on leaf strip (14L, 14R) are made from at least one of a plant leaf and a tree leaf. The tree leaf is considered to be a coconut tree leaf or a palm tree leaf. It is also within the scope of the invention to make the main leaf strip (12) and each add-on leaf strip (14L, 14R) from any other plant leaf or tree leaf. At least one of the abaxial portion (12Y) of the main leaf strip (12) and the abaxial portion (14LY, 14RY) of each add-on leaf strip (14) is scraped. The scraped abaxial portion (12Y) of main leaf strip (12) becomes scraped abaxial portion (12Y) of elongated rolled member (12R) in the rolled position. A bonding agent is applied on at least one of the scraped abaxial portion (12Y) of elongated rolled member (12R) and the scraped abaxial portion (14LY, 14RY) of each add-on leaf strip (14L, 14R) to attach each add-on leaf strip (14L, 14R) onto corresponding side of elongated rolled member (12R) in which both longitudinal end portions of add-on leaf strip (14L) overlap with corresponding longitudinal end portions of another add-on leaf strip (14R) thereby facilitating formation of the bio-degradable food handling device (10), as shown in FIG. 2b). The elongated rolled member (12R) is retained in a rolled position on the elongated fixture member (R) by at least one of engaging holding members on both ends of the elongated rolled member (12R), blowing hot air to the main leaf strip (12) and applying a bonding agent on at least a portion of the leaf strip (12). The holding members are removed after attachment of the add-on leaf strip assembly (14) on to elongated rolled member (12R). For the purpose of this description and ease of understanding, the bonding agent is considered to be a food grade water resistant adhesive and the holding member is considered to be a clip. The bonding agent is bio-degradable or non-biodegradable. The bio-degradable food handling device (10) is a multi-layered bio-degradable food handling device in which the main leaf strip (12) forms a first layer and each add-on leaf strip (14L, 14R) forms a second layer. It is also within the scope of the invention to use more number of add-on leaf strips to form three layered or more than three layered bio-degradable food handling device (10). An inner portion (10X) and an outer portion (10Y) of the bio-degradable food handling device (10) is the adaxial portion (12X) of main leaf strip (12) and the adaxial portion (14LX, 14RX) of add-on leaf strips (14L, 14RY) respectively. The multi-layered bio-degradable food handling device (10), as shown in FIG. 2c) is removed from the elongated fixture member (R) after curing of the bonding agent therein to use the bio-degradable food handling device (10) as at least one of the drinking straw, the stirrer, the chopstick, the balloon stick and the candy stick. The bio-degradable food handling device (10) defines a piercing portion adapted to pierce a seal of at least one of a tumbler, a can, a tetra pack, a drinkable storage can and a food storage pack.

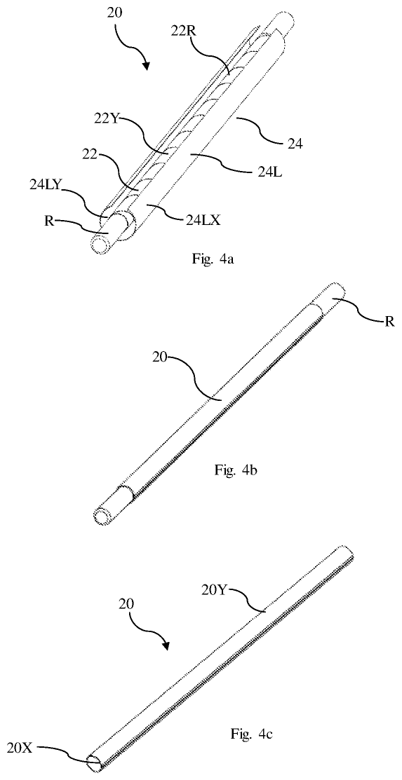

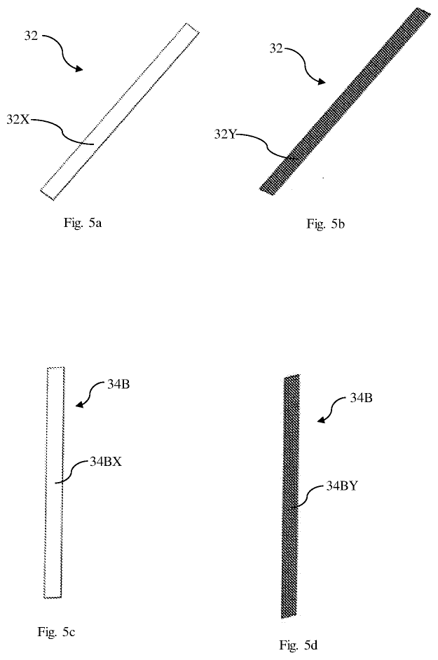

FIG. 4a depicts a perspective view of a bio-degradable food handling device (20), where a main leaf strip (22) is in a spiral rolled onto an elongated fixture member (R) and an add-on leaf strip (24L) is in an exploded view condition, according to the second embodiment as disclosed herein. In an embodiment, the bio-degradable food handling device (20) includes a main leaf strip (22) and an add-on leaf strip assembly (24). For the purpose of this description and ease of understanding, the bio-degradable food handling device (20) is explained herein with below reference to be used as at least one of a drinking straw, a stirrer, a chopstick, a balloon stick and a candy stick. However, it is also within the scope of the invention to use the bio-degradable food handling device (20) for handling any other types of eatables, dairy based foods and any other types of food without otherwise deterring the intended function of the bio-degradable food handling device (20) as can be deduced from the description and corresponding drawings.

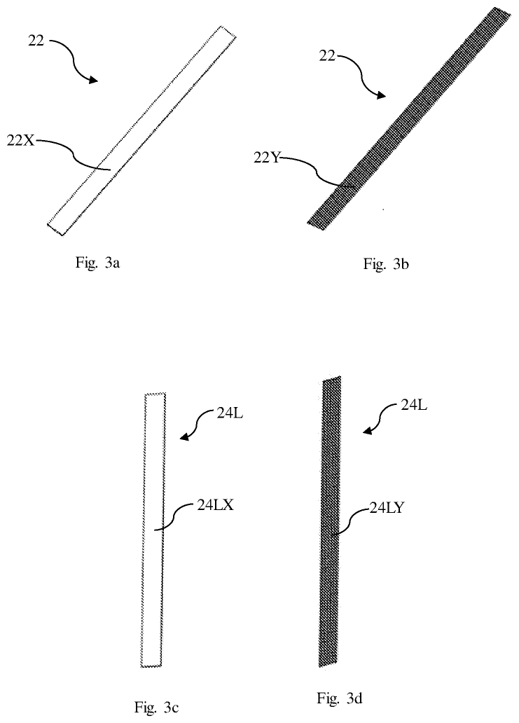

The main leaf strip (22) defines an adaxial portion (22X), as shown in FIG. 3a) and an abaxial portion (22Y), as shown in FIG. 3b). The main leaf strip (22) adapted to be rolled on an elongated fixture member (R), as shown in FIG. 4a) to facilitate formation of an elongated rolled member (22R), as shown in FIG. 4a). For the purpose of this description and ease of understanding, the elongated fixture member (R) is considered to be rod or a tube.

The add-on leaf strip assembly (24) is adapted to be attached to the elongated rolled member (22R) thereby facilitating formation of the bio-degradable food handling device (20). The add-on leaf strip assembly (24) includes an add-on leaf strip (24L), as shown in FIG. 3c, FIG. 3d and FIG. 4a). The add-on leaf strip (24L) defines an adaxial portion (24LX), as shown in FIG. 3c) and an abaxial portion (24LY), as shown in FIG. 3d). The main leaf strip (22) and the add-on leaf strip (24L) are made from at least one of a plant leaf and a tree leaf. It is also within the scope of the invention to make the main leaf strip (22) and at least one add-on leaf strip (24L) from any other plant leaf or tree leaf. The tree leaf is considered to be a coconut tree leaf or a palm tree leaf. At least one of the abaxial portion (22Y) of main leaf strip (22) and the abaxial portion (24LY) of the add-on leaf strip (24L) is scraped. The scraped abaxial portion (22Y) of the main leaf strip (22) becomes scraped abaxial portion (22Y) of the elongated rolled member (22R) in the rolled position. A bonding agent is applied on at least one of the scraped abaxial portion (22Y) of said elongated rolled member (22R) and the scraped abaxial portion (24LY) of said add-on leaf strip (24L) to attach said add-on leaf strip (24L) onto said elongated rolled member (22R) thereby facilitating formation of the bio-degradable food handling device (20), as shown in FIG. 4b). The elongated rolled member (22R) is retained in a rolled position on the elongated fixture member (R) by at least one of engaging holding members on both ends of the elongated rolled member (22R), blowing hot air to the main leaf strip (22) and applying the bonding agent on at least a portion of the leaf strip (22). The holding members are removed after attachment of the add-on leaf strip assembly (24) on to elongated rolled member (22R). For the purpose of this description and ease of understanding, the bonding agent is considered to be a food grade water resistant adhesive and the holding member is considered to be a clip. The bonding agent is bio-degradable or non-biodegradable. The bio-degradable food handling device (20) is a multi-layered bio-degradable food handling device in which the main leaf strip (22) forms a first layer and the add-on leaf strip (24L) forms a second layer. It is also within the scope of the invention to use more number of add-on leaf strips to form three layered or more than three layered bio-degradable food handling device (20). An inner portion (20X), as shown in FIG. 4c) and an outer portion (20Y), as shown in FIG. 4c) of the bio-degradable food handling device (20) is the adaxial portion (22X) of the main leaf strip (22) and the adaxial portion (24LX) of the add-on leaf strip (24L) respectively. The multi-layered bio-degradable food handling device (20), as shown in FIG. 4c) is removed from the elongated fixture member (R) after curing of the bonding agent therein to use the bio-degradable food handling device (20) as at least one of the drinking straw, the stirrer, the chopstick, the balloon stick and the candy stick. The bio-degradable food handling device (20) defines a piercing portion adapted to pierce a seal of at least one of a tumbler, a can, a tetra pack, a drinkable storage can and a food storage pack.

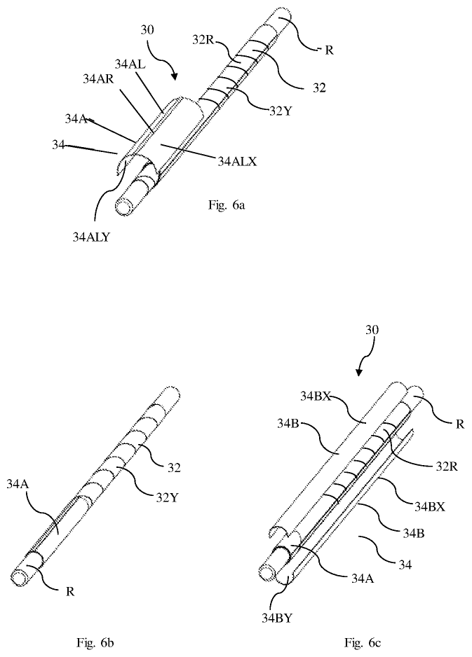

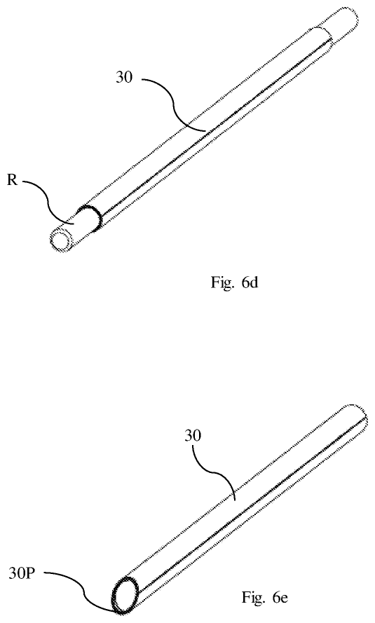

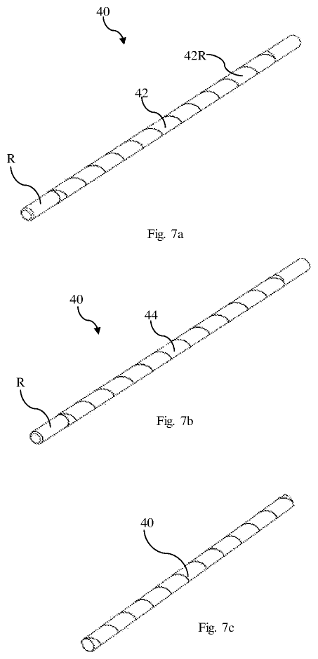

FIG. 6a depicts a perspective view of a bio-degradable food handling device (30), where a main leaf strip (32) is in a spiral rolled onto an elongated fixture member (R) and an add-on leaf section (34A) is in an exploded view condition, according to the third embodiment as disclosed herein. In an embodiment, the bio-degradable food handling device (30) includes a main leaf strip (32) and an add-on leaf strip assembly (34), as shown in FIG. 6a and FIG. 6c). For the purpose of this description and ease of understanding, the bio-degradable food handling device (30) is explained herein with below reference to be used as at least one of a drinking straw, a stirrer, a chopstick, a balloon stick and a candy stick. However, it is also within the scope of the invention to use the bio-degradable food handling device (30) for handling any other types of eatables, dairy based foods and any other types of food without otherwise deterring the intended function of the bio-degradable food handling device (20) as can be deduced from the description and corresponding drawings.

The main leaf strip (32) defines an adaxial portion (32X), as shown in FIG. 5a) and an abaxial portion (32Y), as shown in FIG. 5b). The main leaf strip (32) is adapted to be rolled on an elongated fixture member (R), as shown in FIG. 6a) to facilitate formation of an elongated rolled member (32R), as shown in FIG. 6a). For the purpose of this description and ease of understanding, the elongated fixture member (R) is considered to be rod or a tube.

The add-on leaf strip assembly (34) adapted to be attached to said elongated rolled member (34R) thereby facilitating formation of the bio-degradable food handling device (30). The add-on leaf strip assembly (34) includes an add-on leaf section (34A), as shown in FIG. 6a) and a plurality of add-on leaf strips (34B), only one of which is shown in FIG. 5c and FIG. 5d). The add-on leaf section (34A) includes a midrib (34AR), as shown in FIG. 6a) and a leaf portion (34AL), as shown in FIG. 6a) extending on both sides of the midrib (34AR). The leaf portion (34AL) defines an adaxial portion (34ALX), as shown in FIG. 6a) and an abaxial portion (34ALY), as shown in FIG. 6a). Each add-on leaf strip (34B) defines an adaxial portion (34BX), as shown in FIG. 5c and FIG. 6c) and an abaxial portion (34BY), as shown in FIG. 5c and FIG. 6c). The main leaf strip (32), the add-on leaf section (34A) and each add-on leaf strip (34B) are made from at least one of a plant leaf and a tree leaf. The tree leaf is considered to be a coconut tree leaf or a palm tree leaf. It is also within the scope of the invention to make the main leaf strip (32), the add-on leaf section (34A) and each leaf strip (34B) from any other plant leaf or tree leaf. At least one of the abaxial portion (32Y) of the main leaf strip (32), the abaxial portion (34ALY) of the leaf portion (34AL) of the leaf section (34A) and the abaxial portion (34BY) of each add-on leaf strip (34B) is scraped. The scraped abaxial portion (32Y) of the main leaf strip (32) becomes scraped abaxial portion (32Y) of the elongated rolled member (32R) in the rolled position. A bonding agent is applied on at least one of the scraped abaxial portion (32Y) of the elongated rolled member (32R) and the scraped abaxial portion (34ALY) of the leaf portion (34AL) of the add-on leaf section (34A) to attach the add-on leaf section (34A) onto the elongated rolled member (32R). Further, the bonding agent is applied on the scraped abaxial portion (34BY) of the add-on leaf strip (34B) to attach the add-on leaf strip (34B) onto at least one of the add-on leaf section (34A) and the elongated rolled member (32R) thereby facilitating formation of the bio-degradable food handling device (30), as shown in FIG. 6d). The add-on leaf section (34A) is sandwiched in between the elongated rolled member (32R) and the add-on leaf strip (34B). The elongated rolled member (32R) is retained in a rolled position on the elongated fixture member (R) by at least one of engaging holding members on both ends of the elongated rolled member (32R), blowing hot air to the main leaf strip (32) and applying the bonding agent on at least a portion of the leaf strip (32). The holding members are removed after attachment of the add-on leaf strip assembly (34) on to elongated rolled member (32R). For the purpose of this description and ease of understanding, the bonding agent is considered to be a food grade water resistant adhesive and the holding member is considered to be a clip. The bonding agent is bio-degradable or non-biodegradable. The bio-degradable food handling device (30) is a multi-layered bio-degradable food handling device in which the main leaf strip (32) forms a first layer and the add-on leaf section (34A) forms a second layer and said add-on leaf strip (34B) forms a third layer. It is also within the scope of the invention to use more number of add-on leaf strips and/or leaf sections to form four layered or more than four layered bio-degradable food handling device (10). An inner portion (30X) and an outer portion (30Y) of the bio-degradable food handling device (30) is the adaxial portion (32X) of the main leaf strip (32) and the adaxial portion (34BX) of the add-on leaf strip (34B) respectively. The multi-layered bio-degradable food handling device (30), as shown in FIG. 6e) is removed from the elongated fixture member (R) after curing of the bonding agent therein to use the bio-degradable food handling device (30) as at least one of the drinking straw, the stirrer, the chopstick, the balloon stick and the candy stick. The bio-degradable food handling device (30) defines a piercing portion (30P), as shown in FIG. 6e) adapted to pierce a seal of at least one of a tumbler, a can, a tetra pack, a drinkable storage can and a food storage pack.

FIG. 7a depicts a perspective view of a bio-degradable food handling device (40), where a first leaf strip (42) is spiral rolled onto an elongated fixture member (R), according to embodiments as disclosed herein. In an embodiment, the bio-degradable food handling device (40) includes a first leaf strip (42) and at least one add-on leaf strip (44). For the purpose of this description and ease of understanding, the bio-degradable food handling device (40) is explained herein with below reference to be used as at least one of a drinking straw, a stirrer, a chopstick, a balloon stick and a candy stick. However, it is also within the scope of the invention to use the bio-degradable food handling device (40) for handling any other types of eatables, dairy based foods and any other types of food without otherwise deterring the intended function of the bio-degradable food handling device (40) as can be deduced from the description and corresponding drawings.

The first leaf strip (42) defines an adaxial portion and an abaxial portion. The add-on leaf strip (44) defines an adaxial portion and an abaxial portion. The abaxial portion of the first leaf strip (42) and the abaxial portion of the ad-on leaf strip (44) are scraped. A bonding agent is applied on at least a longitudinal edge portion of the abaxial portion of the first leaf strip (42) to attach the longitudinal edge portion with corresponding portion of the first strip (42) when the first leaf strip (42) is adapted to be spiral rolled onto an elongated fixture member (R) to facilitate formation of an elongated rolled member (42R), as shown in FIG. 7a). For the purpose of this description and ease of understanding, the elongated fixture member (R) is considered to be rod or a tube. The first leaf strip (42) and the add-on leaf strip (44) are made from at least one of a plant leaf and a tree leaf. The tree leaf is considered to be a coconut tree leaf or a palm tree leaf. It is also within the scope of the invention to make the first leaf strip (42) and the add-on leaf strip (44) from any other plant leaf or tree leaf. The scraped abaxial portion of the first leaf strip (42) becomes scraped abaxial portion of the elongated rolled member (42R) in the rolled position. The elongated rolled member (42R) is retained in a rolled position on the elongated fixture member (R) by at least one of engaging holding members on both ends of the elongated rolled member (42R), blowing hot air to the main leaf strip (42) and applying the bonding agent on at least a portion of the first leaf strip (42). The holding members are removed after attachment of the add-on leaf strip (44) on to elongated rolled member (42R). For the purpose of this description and ease of understanding, the bonding agent is considered to be a food grade water resistant adhesive and the holding member is considered to be a clip. A bonding agent is applied on at least one of the abaxial portion of the add-on leaf strip (44) and the abaxial portion of the elongated rolled member (42R). The abaxial portion of the add-on leaf strip (44) is spiral rolled onto the abaxial portion of the elongated rolled member (42R) to attach the add-on leaf strip (44) onto the elongated rolled member (42R) thereby facilitating formation of the bio-degradable food handling device (40). The bonding agent is bio-degradable or non-biodegradable. The bio-degradable food handling device (40) is a multi-layered bio-degradable food handling device in which the first leaf strip (42) forms a first layer and the add-on leaf strip (44) forms a second layer. It is also within the scope of the invention to use more number of add-on leaf strips to form a three layered or more than three layered bio-degradable food handling device (40) An inner portion and an outer portion (40Y) of the bio-degradable food handling device (40) is the adaxial portion of the first leaf strip (42) and the adaxial portion of the add-on leaf strip (44) respectively. The multi-layered bio-degradable food handling device (40) is removed from the elongated fixture member (R) after curing of the bonding agent therein to use the bio-degradable food handling device (40) as at least one of the drinking straw, the stirrer, the chopstick, the balloon stick and the candy stick. The bio-degradable food handling device (40) defines a piercing portion adapted to pierce a seal of at least one of a tumbler, a can, a tetra pack, a drinkable storage can and a food storage pack.

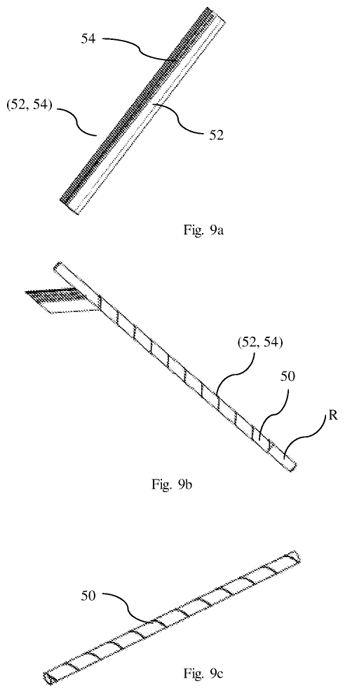

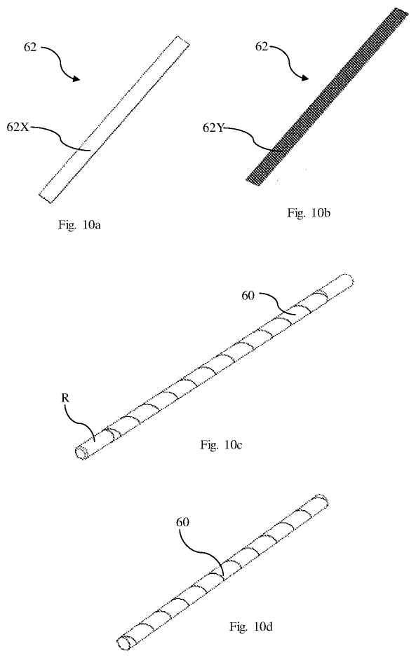

FIG. 9a depicts a perspective view of a bio-degradable food handling device (50), where a first leaf strip (52) is overlapped onto a second leaf strip (54), according to embodiments as disclosed herein. In an embodiment, the bio-degradable food handling device (50) includes a first leaf strip (52) and a second leaf strip (54). For the purpose of this description and ease of understanding, the bio-degradable food handling device (50) is explained herein with below reference to be used as at least one of a drinking straw, a stirrer, a chopstick, a balloon stick and a candy stick. However, it is also within the scope of the invention to use the bio-degradable food handling device (50) for handling any other types of eatables, dairy based foods and any other types of food without otherwise deterring the intended function of the bio-degradable food handling device (50) as can be deduced from the description and corresponding drawings.

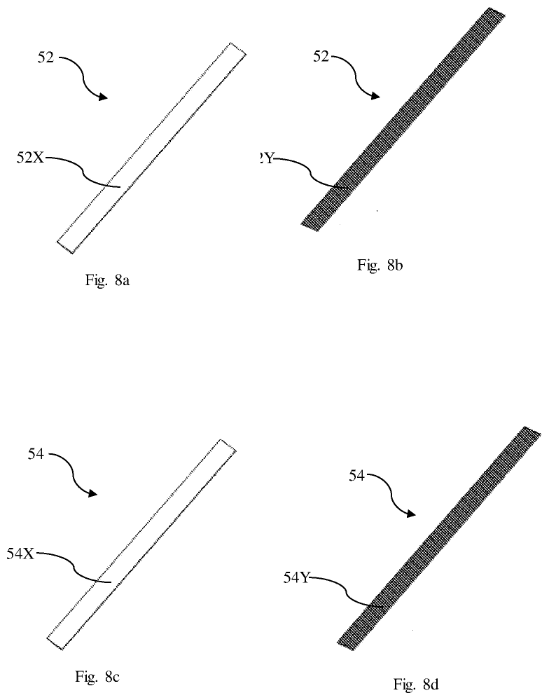

The first leaf strip (52) defines an adaxial portion (52X), as shown in FIG. 8a) and an abaxial portion (52Y), as shown in FIG. 8b). The second leaf strip (54) defines an adaxial portion (54X), as shown in FIG. 8c) and an abaxial portion (54Y), as shown in FIG. 8d). The abaxial portion (52Y) of the first leaf strip (52) and the abaxial portion (54Y) of the second leaf strip (54) are scraped. The first leaf strip (52) and the second leaf strip (54) is made from at least one of a plant leaf and a tree leaf. The tree leaf is considered to be a coconut tree leaf or a palm tree leaf. It is also within the scope of the invention to make the first leaf strip (52) and the second leaf strip (54) from any other plant leaf or tree leaf. A bonding agent is applied on at least one of half of the abaxial portion (52Y) of the first leaf strip (52) along a longitudinal direction of the first leaf strip (52) and a half of the abaxial portion (54Y) of the second leaf strip (54) along a longitudinal direction of the second leaf strip (54) to attach the first leaf strip (52) onto the second leaf strip (54) in which half of the abaxial portion (52Y) of the first leaf strip (52) is overlapped onto half of the abaxial portion (54Y) of the second leaf strip (54) thereby facilitating formation of an overlapped first and second leaf strip (52, 54), as shown in FIG. 9a). The overlapped first and second leaf strip (52, 54) is spiral rolled on an elongated fixture member (R), as shown in FIG. 9b) to facilitate formation of the bio-degradable food handling device (50). It is also within the scope of the invention to overlap the first leaf strip (52) onto the second leaf strip (54) at any other position. For the purpose of this description and ease of understanding, the elongated fixture member (R) is considered to be a rod or a tube. The bonding agent is applied on a longitudinal edge portion of the overlapped first and second leaf strip (52, 54) to attach the longitudinal edge portion with corresponding portion of the overlapped first and second leaf strip (52, 54) thereby facilitating formation of the bio-degradable food handling device (50) when the overlapped first and second leaf strip (52, 54) is spiral rolled on the elongated fixture member (R), as shown in FIG. 9b. The multi-layered bio-degradable food handling device (50), as shown in FIG. 9c) is removed from the elongated fixture member (R) after curing of the bonding agent therein to use the bio-degradable food handling device (50) as at least one of the drinking straw, the stirrer, the chopstick, the balloon stick and the candy stick. For the purpose of this description and ease of understanding, the bonding agent is considered to be a food grade water resistant adhesive. The bonding agent is bio-degradable or non-biodegradable. The bio-degradable food handling device (50) defines a piercing portion adapted to pierce a seal of at least one of a tumbler, a can, a tetra pack and a drinkable storage can and a food storage pack.

FIG. 10d depicts a perspective view of a bio-degradable food handling device (60), according to embodiments as disclosed herein. In an embodiment, the bio-degradable food handling device (60) includes a leaf strip (62), as shown in FIG. 10c). For the purpose of this description and ease of understanding, the bio-degradable food handling device (60) is explained herein with below reference to be used as at least one of a drinking straw, a stirrer, a chopstick, a balloon stick and a candy stick. However, it is also within the scope of the invention to use the bio-degradable food handling device (60) for handling any other types of eatables, dairy based foods and any other types of food without otherwise deterring the intended function of the bio-degradable food handling device (60) as can be deduced from the description and corresponding drawings.

The leaf strip (62) defines an adaxial portion (62X), as shown in FIG. 10a) and an abaxial portion (62Y), as shown in FIG. 10b). The abaxial portion (62Y) of the leaf strip (62) is scraped. A bonding agent is applied on at least a longitudinal edge portion of the scraped abaxial portion (62Y) of the leaf strip (62). The leaf strip (62) is made from at least one of a plant leaf and a tree leaf. The tree leaf is considered to be a coconut tree leaf or a palm tree leaf. It is also within the scope of the invention to make the leaf strip (62) from any other plant leaf or tree leaf. The leaf strip (62) is adapted to be rolled on an elongated fixture member (R), as shown in FIG. 10c) to facilitate formation of the bio-degradable food handing device (60), as shown in FIG. 10c). For the purpose of this description and ease of understanding, the elongated fixture member (R) is considered to be rod or a tube. The longitudinal edge portion of the scraped abaxial portion (62Y) is attached onto corresponding portion of the adaxial portion (62X) of the leaf strip (62) during rolling of the leaf strip (62) onto the elongated fixture member (R) thereby facilitating formation of said bio-degradable food handing device (60). The bio-degradable food handing device (60) is a single layered bio-degradable food handing device (60). The bio-degradable food handling device (60) defines a piercing portion adapted to pierce a seal of at least one of a tumbler, a can, a tetra pack and a drinkable storage can and a food storage pack. The single-layered bio-degradable food handling device (60), as shown in FIG. 10d) is removed from the elongated fixture member (R) after curing of the bonding agent therein to use the bio-degradable food handling device (60) as at least one of the drinking straw, the stirrer, the chopstick, the balloon stick and the candy stick.

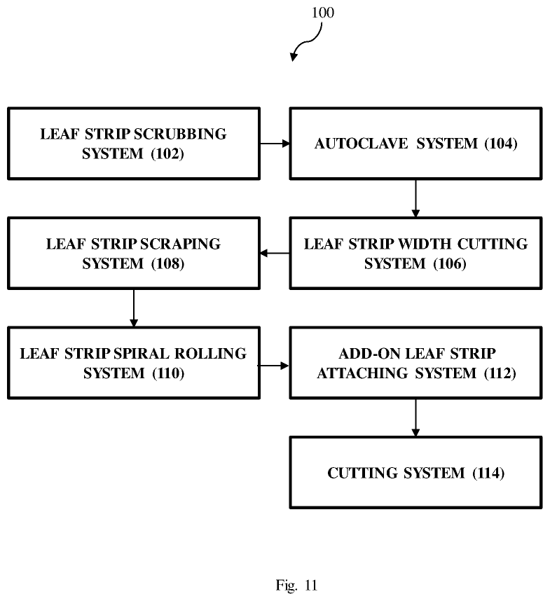

FIG. 11 depicts a schematic view of a system (100) for making a multilayered bio-degradable food handling device (100), according to embodiments as disclosed herein. In an embodiment, the system (100) includes a leaf strip scrubbing system (102), an autoclave system (104), a leaf strip width cutting system (106), a leaf strip scraping system (108), a leaf strip spiral rolling system (110), an add-on leaf strip attaching system (112) and a cutting system (114). For the purpose of this description and ease of understanding, the system (100) is explained herein with below reference to making the bio-degradable food handling device (100).

In an embodiment, the leaf strip scrubbing system (102) is adapted to clean the leaf strips (12, 14L, 14R, 22, 32, 42, 52 and 62) and also to remove the pesticide from the leaf strips by scrubbing the leaf strips. In an embodiment, the leaf strip scrubbing system (102) includes a plurality of scrubbers adapted to scrub the adaxial portion and the abaxial portion of the leaf strips thereby cleaning the leaf strips and also removing the pesticide from the leaf strips.

In an embodiment, the autoclave system (104) is adapted to sterilize the leaf strips (12, 14L, 14R, 22, 32, 42, 52 and 62) and to make the leaf strips flexible and also to generate natural wax from the adaxial portion of the leaf strips.

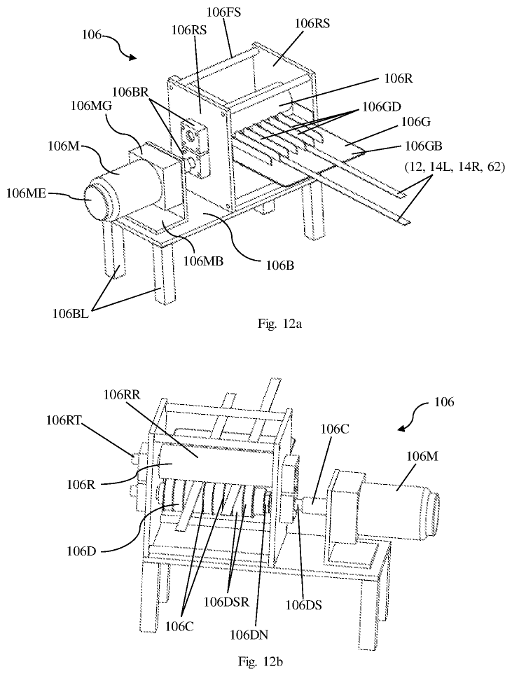

FIG. 12a depicts a perspective view of a leaf strip width cutting system (106), according to embodiments as disclosed herein. In an embodiment, the leaf strip width cutting system (106) is adapted to cut a portion of the leaf strips (12, 14L, 14R, 22, 32, 42, 52 and 62) along a longitudinal direction of the leaf strips to obtain the leaf strips (12, 14L, 14R, 22, 32, 42, 52 and 62) with predefined width. The leaf strip width cutting system (106) includes a driving unit (106M), a driving roller assembly (106D), as shown in FIG. 12b), a driven roller assembly (106R), as shown in FIG. 12 and FIG. 12b), a coupler (106C), as shown in FIG. 12b), a leaf strip guiding unit (106G), a base (106B), a driving unit mounting member (106MB), a plurality of bearing blocks (106BR), a plurality of bearings (not shown), a plurality of roller support frames (106RS) and a plurality of frame reinforcing members (106FS). The driving unit (106M) is adapted to drive the driving roller assembly (106D). The driving unit (106M) includes a driving means (106ME) and a speed reduction gearbox (106MG). The driving means (106ME) is adapted to drive the driving roller assembly (106D) through the speed reduction gearbox (106MG). For the purpose of this description and ease of understanding, the driving means (106ME) is considered to be an electric motor. However, it is also within the scope of the invention to consider the driving means (106ME) as any of a pneumatic motor, a hydraulic motor and any other rotating mechanism and accordingly the speed multiplication gearbox or speed reduction gearbox can be selected based on the type of driving means without otherwise deterring the intended function of the driving means (106ME) as can be deduced from the description and corresponding drawings. The speed reduction gearbox (106MG) is adapted to reduce the speed and increase the power transmitted from the driving means (106ME) to the driving roller assembly (106D).

The driving roller assembly (106D) is adapted to cut a portion of the leaf strips (12, 14L, 14R, 22, 32, 42, 52 and 62) along the longitudinal direction of the leaf strips to obtain the leaf strips with predefined width when the leaf strips is being feed in between the driving roller assembly (106D) and the driven roller assembly (106R). The driving roller assembly (106D) drives the driven roller assembly (106R). The driving roller assembly (106D) is driven by the driving unit (106M). In an embodiment, the driving roller assembly (106D) includes a shaft (106DS), a plurality of cutting elements (106DC), a plurality of spacers (106DSR), a lock nut (106DN), as shown in FIG. 12b) and a driving gear (not shown). The shaft (106DS) is rotatably connected to the driving unit (106M) through the coupler (106C). The shaft (106DS) is supported by the roller support frames (106RS) through corresponding bearings (not shown) and corresponding bearing blocks (106BR). The shaft (106DS) is freely rotating on corresponding bearing blocks (106BR) through corresponding bearings (not shown). At least one cutting element (106DC) is adapted to cut a portion of the leaf strips along the longitudinal direction of the leaf strips to obtain the leaf strips with predefined width when the leaf strips is being feed in between the driving roller assembly (106D) and the driven roller assembly (106R). For the purpose of this description and ease of understanding, each cutting element (106DC) is considered to be a cutting disc. The plurality of cutting elements (106DC) is mounted onto the shaft (106DS), where each cutting element (106DC) is spaced away from adjacent cutting element (106DC). The plurality of spacers (106DSR) is adapted to feed the leaf strips to the cutting elements (106DC). Each spacer (106DSR) is mounted onto the shaft (106DS) to space away each cutting element (106DC) from adjacent cutting element (106DC). The spacer (106DSR) which is near one end of the shaft (106DS) is locked in its position by engaging the spacer (106a) with a stepped portion of the shaft (106DS) and another spacer (106DSR) which is near another end of the shaft (106DS) is locked by engaging the locknut (1406DN) with the spacer (106DSR) thereby locking the plurality of spacers (106DSR) and the plurality of cutting elements (106DC) in its position. The lock nut (106DN) is adapted to lock the plurality of spacers (106DSR) and the plurality of cutting elements (106DC) in its position thereby restricting a movement of the plurality of spacers (106DSR) and the plurality of cutting elements (106DC). The driving gear (not shown) is adapted to drive a driven gear (not shown) which is mounted on a shaft (106RT) of the driven roller assembly (106R).

The driven roller assembly (106R) is adapted to feed the leaf strips (12, 14L, 14R, 22, 32, 42, 52 and 62) to the cutting elements (106DC) of the driving roller assembly (106D). The driven roller assembly (106R) is driven by the driving roller assembly (106D). In an embodiment, the driven roller assembly (106R) includes a shaft (106RT), a roller (106RR), as shown in FIG. 12b), a lock nut (not shown) and a driven gear (not shown). The shaft (106RR) is supported by the roller support frames (106RS) through corresponding bearings (not shown) and corresponding bearing blocks (106BR). The shaft (106RR) is freely rotating on corresponding bearing blocks (106BR) through corresponding bearings (not shown). The roller (106RR) is adapted to feed the leaf strips to the cutting elements (106DC) of the driving roller assembly (106D). The roller (106RR) is mounted onto the shaft (106RT), where the roller (106RR) extends along a longitudinal direction of the shaft (106RT). One end of the roller (106RR) is engaged with a stepped portion (not shown) of the shaft (106RT) and another end of the roller (106RR) is engaged with the locknut (not shown) thereby the roller (106RR) is locked in its position. The lock nut (not shown) is adapted to lock the roller (106RR) in its position thereby restricting a movement of the roller (106RR). The driven gear (not shown) is mounted on the shaft (106RT), where the driven gear (not shown) is rotatably connected to the driving gear (not shown) of the driving roller assembly (106D). The driven gear (not shown) is driven by the driving gear (not shown) of the driving roller assembly (106D).

The coupler (106C) is adapted to couple the shaft (106DS) of the driving roller assembly (106D) to an output shaft (not shown) of the driving unit (106M). The leaf strip guiding unit (106G) is adapted to guide the leaf strips in between the spacers (106DSR) of the driving roller assembly (106D) and the roller (106RR) of the driven roller assembly (106R). The leaf strip guiding unit (106G) includes a base (106GB) and a plurality of dividers (106GD), as shown in FIG. 12a). The base (106GB) is adapted to mount the plurality of dividers (106GD). One end of the base (106GB) of the leaf strip guiding unit (106G) is connected to each roller support frame (106RS) and another end of the base (106GB) is suspended freely. The plurality of dividers (106GD) of the leaf strip guiding unit (106G) is adapted to separate and guide the leaf strips towards and in between the driving roller assembly (106D) and the driven roller assembly (106R). One end of each divider (106GD) is in front of and near to and in between the spacers (106DSR) of the driving roller assembly (106D) and the rollers (106RR) of the driven roller assembly (106R). For the purpose of this description and ease of understanding, each divider (106GD) is considered to be a longitudinal plate.

The base (106B) is adapted to support the driving unit (106M), the driving roller assembly (106D) and the driven roller assembly (106R) through the driving unit mounting member (106MB) and the plurality of roller support frames (106RS). The base (106B) is supported by a plurality of legs (106BL), as shown in FIG. 12a). The driving unit mounting member (106MB) is adapted to mount the driving unit (106M). For the purpose of this description and ease of understanding, the driving unit mounting member (106MB) is considered to be a L-bracket. Each bearing block (106BR) is adapted to support corresponding each bearing (not shown). The plurality of roller support frames (106RS) is adapted to support the driving roller assembly (106D) and the driven roller assembly (106R). The plurality of frame reinforcing members (106FS) is adapted to reinforce the roller support frames (106RS). The ends of each frame reinforcing member (106FS) are connected to the roller support frames (106RS). For the purpose of this description and ease of understanding, each frame reinforcing member (106FS) is considered to be an elongated rod or an elongated tube.

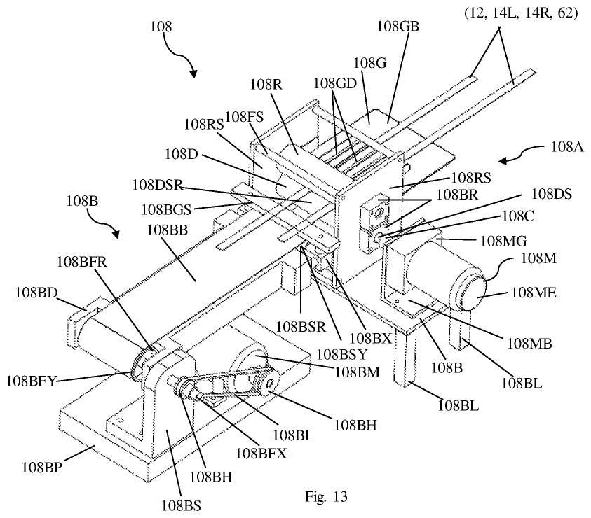

FIG. 13 depicts a perspective view of a leaf strip scraping system (108), according to embodiments as disclosed herein. In an embodiment, the leaf strip scraping system (108) is adapted to scrape an abaxial portion of the leaf strip (12, 14L, 14R, 22, 32, 42, 52 and 62). The leaf strip scraping system (108) includes a leaf strip feeding device (108A) and a leaf strip scraping device (108B). The leaf strip feeding device (108A) is adapted to feed the leaf strips to the leaf strip scraping device (108B). In an embodiment, the leaf strip feeding device (108A) includes a driving unit (108M), a driving roller assembly (108D), a driven roller assembly (108R), a coupler (108C), a leaf strip guiding unit (108G), a base (108B), a driving unit mounting member (108MB), a plurality of bearing blocks (108BR), a plurality of bearings (not shown), a plurality of roller support frames (108RS), a plurality of frame reinforcing members (108FS). The driving unit (108M) is adapted to drive the driving roller assembly (108D). The driving unit (108M) includes a driving means (108ME) and a speed reduction gearbox (108MG). The driving means (108ME) is adapted to drive the driving roller assembly (108D) through the speed reduction gearbox (108MG). For the purpose of this description and ease of understanding, the driving means (108ME) is considered to be an electric motor. However, it is also within the scope of the invention to consider the driving means (108ME) as any of a pneumatic motor, a hydraulic motor and any other rotating mechanism and accordingly the speed multiplication gearbox or speed reduction gearbox can be selected based on the type of driving means without otherwise deterring the intended function of the driving means (108ME) as can be deduced from the description and corresponding drawings. The speed reduction gearbox (108MG) is adapted to reduce the speed and increase the power transmitted from the driving means (108ME) to the driving roller assembly (108D).

The driving roller assembly (108D) is adapted to feed the leaf strips (12, 14L, 14R, 22, 32, 42, 52 and 62) to the leaf strip scraping device (108B). The driving roller assembly (108D) drives the driven roller assembly (108R). The driving roller assembly (108D) is driven by the driving unit (108M). In an embodiment, the driving roller assembly (108D) includes a shaft (108DS), a roller (108DSR), a lock nut (not shown) and a driving gear (not shown). The shaft (108DS) is rotatably connected to the driving unit (108M) through the coupler (108C). The shaft (108DS) is supported by the roller support frames (108RS) through corresponding bearings (not shown) and corresponding bearing blocks (108BR). The shaft (108DS) is freely rotating on corresponding bearing blocks (108BR) through corresponding bearings (not shown). The roller (108DSR) is adapted to feed the leaf strips to the leaf strip scraping device (108B). The roller (108DSR) is mounted onto the shaft (108DS), where the roller (108DSR) extends along a longitudinal direction of the shaft (108DS). One end of the roller (108DSR) is engaged with a stepped portion (not shown) of the shaft (108DS) and another end of the roller (108DSR) is engaged with the locknut (not shown) thereby the roller (108DSR) is locked in its position. The lock nut (not shown) is adapted to lock the roller (108DSR) in its position thereby restricting a movement of the roller (108DSR). The driving gear (not shown) is adapted to drive a driven gear (not shown) which is mounted on a shaft (not shown) of the driven roller assembly (108R).

The driven roller assembly (108R) is adapted to feed the leaf strips (12, 14L, 14R, 22, 32, 42, 52 and 62) to leaf strip scraping device (108B). The driven roller assembly (108R) is driven by the driving roller assembly (108D). In an embodiment, the driven roller assembly (108R) includes a shaft (not shown), a roller (108RR), as shown in FIG. 13), a lock nut (not shown) and a driven gear (not shown). The shaft (108RR) is supported by the roller support frames (108RS) through corresponding bearings (not shown) and corresponding bearing blocks (108BR). The shaft (108RR) is freely rotating on corresponding bearing blocks (108BR) through corresponding bearings (not shown). The roller (108RR) is adapted to feed the leaf strips leaf strip scraping device (108B). The roller (108RR) is mounted onto the shaft (not shown), where the roller (108RR) extends along a longitudinal direction of the shaft (not shown). One end of the roller (108RR) is engaged with a stepped portion (not shown) of the shaft (not shown) and another end of the roller (108RR) is engaged with the locknut (not shown) thereby the roller (108RR) is locked in its position. The lock nut (not shown) is adapted to lock the roller (108RR) in its position thereby restricting a movement of the roller (108RR). The driven gear (not shown) is mounted on the shaft (not shown), where the driven gear (not shown) is rotatably connected to the driving gear (not shown) of the driving roller assembly (108D). The driven gear (not shown) is driven by the driving gear (not shown) of the driving roller assembly (108D).

The coupler (108C) is adapted to couple the shaft (108DS) of the driving roller assembly (108D) to an output shaft (not shown) of the driving unit (108M). The leaf strip guiding unit (108G) is adapted to guide the leaf strips in between the roller (108DSR) of the driving roller assembly (108D) and the roller (108RR) of the driven roller assembly (108R). The leaf strip guiding unit (108G) includes a base (108GB) and a plurality of dividers (108GD), as shown in FIG. 13). The base (108GB) is adapted to mount the plurality of dividers (108GD). One end of the base (108GB) of the leaf strip guiding unit (108G) is connected to each roller support frame (108RS) and another end of the base (108GB) is suspended freely. The plurality of dividers (108GD) of the leaf strip guiding unit (108G) is adapted to separate and guide the leaf strips towards and in between the driving roller assembly (108D) and the driven roller assembly (108R). One end of each divider (108GD) is in front of and near to and in between the roller (108DSR) of the driving roller assembly (108D) and the roller (108RR) of the driven roller assembly (108R). For the purpose of this description and ease of understanding, each divider (108GD) is considered to be a longitudinal plate.

The base (108B) is adapted to support the driving unit (108M), the driving roller assembly (108D) and the driven roller assembly (108R) through the driving unit mounting member (108MB) and the plurality of roller support frames (108RS). The base (108B) is supported by a plurality of legs (108BL). The driving unit mounting member (108MB) is adapted to mount the driving unit (108M). For the purpose of this description and ease of understanding, the driving unit mounting member (108MB) is considered to be a L-bracket. Each bearing block (108BR) is adapted to support corresponding each bearing (not shown). The plurality of roller support frames (108RS) is adapted to support the driving roller assembly (108D) and the driven roller assembly (108R). The plurality of frame reinforcing members (108FS) is adapted to reinforce the roller support frames (108RS). The ends of each frame reinforcing member (108FS) are connected to the roller support frames (108RS). For the purpose of this description and ease of understanding, each frame reinforcing member (108FS) is considered to be an elongated rod or an elongated tube.

The leaf strip scraping device (108B) is adapted to scrape the abaxial portion of the leaf strips (12, 14L, 14R, 22, 32, 42, 52 and 62). The leaf strip scraping device (108B) includes a driving unit (108BM), a first roller assembly (108BFR), as shown in FIG. 13), a second roller assembly (108BSR), an abrasive belt (108BB), as shown in FIG. 13), a bed (108BD), a platform (108BP), at least one support block (108BS) and a leaf strip scraping setting device (108BGS), as shown in FIG. 13). The driving unit (108BM) is adapted to drive the first roller assembly (108BFR). For the purpose of this description and ease of understanding, the driving unit (108BM) is considered to be an electric motor. However, it is also within the scope of the invention to consider the driving unit (108BM) as any of a pneumatic motor, a hydraulic motor and any other rotating mechanism and accordingly the speed multiplication gearbox or speed reduction gearbox can be used based on the type of driving unit without otherwise deterring the intended function of the driving unit (108BM) as can be deduced from the description and corresponding drawings. The driving unit (108BM) is mounted onto the platform (108BP). The driving unit (108BM) is rotatably connected to the first roller assembly (108BFR). The first roller assembly (108BFR) is adapted to move the abrasive belt (108BB). The first roller assembly (108BFR) includes a shaft (108BFX) and a roller (108BFY), as shown in FIG. 13). The shaft (108BFX) of the first roller assembly (108BFR) is freely rotating on the bed (108BD) and the support block (108BS). The shaft (108BFX) of the first roller assembly (108BFR) is driven by the driving unit (108BM) through a plurality of pulleys (108BH) and a belt (108BI), as shown in FIG. 13), where one pulley (108BH) is mounted on the shaft (108BFX) of the first roller assembly (108BFR) and another pulley (108BH) is mounted on a shaft (not shown) of the driving unit (108BM). The belt (108BI) is adapted to connect the pulleys (108BH). The second roller assembly (108BSR) is adapted to facilitate movement of the abrasive belt (108BB) when the abrasive belt (108BB) is moved by the first roller assembly (108BFR). The second roller assembly (108BSR) includes a shaft (not shown) and a roller (108BSY). The shaft of the second roller assembly (108BSR) is freely rotating on a roller support block (108BX) connected to one end of the bed (108BD). It is also within the scope of the invention to directly and freely rotate the second roller assembly (108BSR) with respect to the bed (108BD). The second roller assembly (108BSR) is spaced away and opposite to the first roller assembly (108BFR). The second roller assembly (108BSR) is near the roller (108DSR) of the driving roller assembly (108D) of the leaf strip feeding device (108A). The abrasive belt (108BB) is adapted to scrape the abaxial portion of the leaf strips. The abrasive belt (108BB) is a closed abrasive belt which is engaged with the roller of (108BFY) of the first roller assembly (108BFR) and the roller (108BSY) of the second roller assembly (108BSR). The bed (108BD) is adapted to support the first roller assembly (108BFR) and the second roller assembly (108BSR). The platform (108BP) is adapted to support the driving unit (108BM) and the bed (108BD). The support block (108BS) is adapted to support the bed (108BD). The support block (108BS) is mounted onto the platform (108BP). The leaf strip scraping setting device (108BGS) is adapted to guide the strip to the abrasive belt (108BB) and also sets the amount of scraping on the leaf strips.

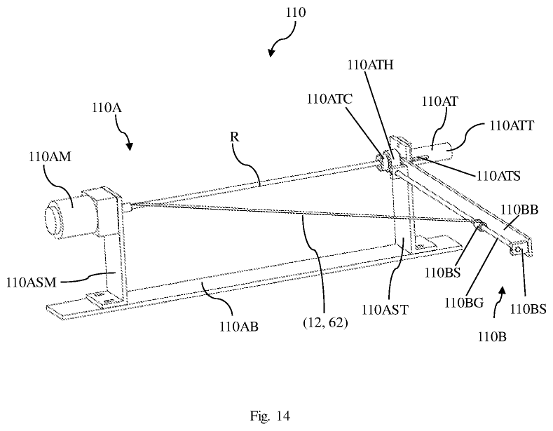

FIG. 14 depicts a perspective view of a leaf strip spiral rolling system (110), according to embodiments as disclosed herein. In an embodiment, the leaf strip spiral rolling system (110) is adapted to spiral roll the leaf strip (12, 22, 32, 42 and 62) on the elongated fixture member (R) to facilitate formation of the elongated rolled member (12R). In one embodiment, the leaf strip spiral rolling system (110) is adapted to facilitate formation of the multi-layered bio-degradable food handing device (10). In another embodiment, the leaf strip spiral rolling system (110) is adapted to facilitate formation of a single layered bio-degradable food handing device (60). In an embodiment, the leaf strip spiral rolling system (110) comprises a leaf strip spiral rolling device (110A), a leaf strip spooling device (not shown), a leaf strip guiding device (110B) and a hot air blower device (not shown). The leaf strip spiral rolling device (110A) is adapted to spiral roll the leaf strip (12, 22, 32, 42 and 62) on the elongated fixture member (R) to facilitate formation of the elongated rolled member (12R, 22R, 32R, 42R). The elongated rolled member (12R) is retained in the rolled position on the elongated fixture member (R) by engaging holding members (not shown) on both ends of the elongated rolled member (12R). For the purpose of this description and ease of understanding, each holding member (not shown) is considered to be a clip. In an embodiment, the leaf strip spiral rolling device (110A) includes a driving unit (110AM), a tail stock assembly (110AT), as shown in FIG. 14), a base (110AB), a driving unit support member (110ASM) and a tail stock support member (110AST), as shown in FIG. 14). The driving unit (110AM) is adapted to rotate the elongated fixture member (R), as shown in FIG. 14) to spiral roll the leaf strip (12) on the elongated fixture member (R) to facilitate formation of the elongated rolled member (12R). For the purpose of this description and ease of understanding, the driving unit (110AM) is considered to be an electric motor with a speed reduction gearbox. However, it is also within the scope of the invention to consider the driving unit (110AM) as any of a pneumatic motor, a hydraulic motor, any other rotating mechanism, powered driving means and mechanical driving means and accordingly the speed multiplication gearbox or speed reduction gearbox can be used based on the type of driving unit without otherwise deterring the intended function of the driving unit (110AM) as can be deduced from the description and corresponding drawings. The driving unit (110AM) is operated by a pedal in which the pedal is engaged or dis-engaged by operator's leg (person pressing or de-pressing the pedal) to switch on or switch off electric current supply to the driving unit (110AM) respectively. In another embodiment, the driving unit (110AM) is operated by a switch or button or lever or any hand operated control means or any other user interface means. In an another embodiment, the driving unit of the leaf strip spiral rolling device (110A) is considered to be an hand operated wheel, where the hand operated wheel is rotated by operator (person rotating the hand operated wheel) to rotate the elongated fixture member (R). The tail stock assembly (110AT) is adapted to support corresponding end of the elongated fixture member (R) and also to facilitate rotation of the elongated fixture member (R) when the elongated fixture member (R) is rotated by the driving unit (110AM). One end of the elongated fixture member (R) is removably connected to the driving unit (110AM) and another end of the elongated fixture member (R) is removably connected to the tail stock assembly (110AT). The tail stock assembly (110AT) includes a tail stock (110ATT), a live center holder (110ATH), a live center (110ATC) and a spring (110ATS). The tailstock (110ATT) is adapted to support the live center holder (110ATH). The tailstock (110ATT) is supported by the tail stock support member (110AST). The live center holder (110ATH) is adapted to hold the live center (110ATC). A portion of the live center holder (110ATH) is loaded into the tailstock (110ATT) through the spring (110ATS). The live center (110ATC) is adapted to position the elongated fixture member (R) and also to hold one end of the elongated fixture member (R). The live center (110ATC) is freely rotating on the live center holder (110ATH). The live center holder (110ATH) is moved in a direction towards the tail stock (110ATT) to remove the elongated fixture member (R) from the live center (110ATC). The base (110AB) is adapted to support the driving unit (110AM) and the tailstock assembly (110AT) through the driving unit support member (110ASM) and the tail stock support member (110AST) respectively. The driving unit support member (110ASM) is mounted on the base (110AB). The driving unit support member (110ASM) is adapted to support the driving unit (110AM). The tail stock support member (110AST) is mounted onto the base (110AB). The tail stock support member (110AST) is adapted to support the tail stock assembly (110AT). The leaf strip is feed to the elongated fixture member (R) manually or semi-automatically.

The leaf strip guiding device (110B) is adapted to guide and move the leaf strip spooling device (not shown) in relation to the rotation of the elongated fixture member (R) by the leaf strip spiral rolling device (110A). In an embodiment, the leaf strip guiding device (110B) includes a guiding member (110BG), a movable member (110BS), a base (110BB) and a plurality of support members (110BS), as shown in FIG. 14). The guiding member (110BG) is adapted to guide the movable member (110BS) and also to facilitate the movement of the movable member (110BS). One end of the guiding member (110BG) is supported by the support member (110BS) and another end of the guiding member (110BG) is supported by another support member (110BS). For the purpose of this description and ease of understanding, the guiding member (110BG) is considered to be a rod or a tube. The movable member (110BS) is movably connected to the guiding member (110BG). The movable member (110BS) is adapted to mount the leaf strip spooling device. The movable member (110BS) moves on the guiding member (110BG) thereby moving the leaf strip spooling device with respect to the rotation of the elongated fixture member (R) by the driving unit (110AM) of the leaf strip rolling device (110A). The plurality of support members (110BS) is adapted to mount the guiding member (110BG) onto the base (110BB). One end of the base (110BB) is connected to the tail stock support member (110AST) of the leaf strip spiral rolling device (110A).

In another embodiment, the leaf strip guiding device (110B) includes a driving unit (not shown) adapted to rotate the guiding member (110BG) to move the movable member (110BS) on the guiding member (110BG) thereby moving the leaf strip spooling device with respect to rotation of the elongated fixture member (R) by the driving unit (110AM) of the leaf strip rolling device (110A). For the purpose of this description and ease of understanding, the driving unit (not shown) is considered to be an electric motor with a speed reduction gearbox and correspondingly the guiding member (110BG) and the movable member is considered to be lead screw and nut respectively. However, it is also within the scope of the invention to consider the driving unit (not shown) as any of a pneumatic motor, a hydraulic motor, any other rotating mechanism, powered driving means and mechanical driving means and accordingly the speed multiplication gearbox or speed reduction gearbox can be used based on the type of driving unit without otherwise deterring the intended function of the driving unit (not shown) of the leaf strip guiding device (110B) as can be deduced from the description and corresponding drawings.

The leaf strip spooling device is adapted to wind the leaf strip (12) of continuous length to facilitate formation of spool leaf strips. To obtain leaf strip of continuous length, one end of the leaf strip is attached to corresponding end of another leaf strip by using the bonding agent and similarly, the plurality of leaf strips are attached in the same manner to facilitate formation the leaf strip of continuous length. The leaf strip spooling device is adapted to feed the leaf strip (12) to the elongated fixture member (R) which is removably connected to the driving unit (110AM) and the live center (110ATC) of the tail stock assembly (110AT) of the leaf strip spiral rolling device (110A). The leaf strip spooling device is directly mounted or freely mounted onto the movably member (110BS) of the leaf strip guiding device (110B). The leaf strip spooling device includes a spool member (not shown) and a plurality of support members (not shown). The spool member (not shown) is adapted to hold the spool leaf strips. Each support member (not shown) is connected on corresponding each side of the spool member (not shown). The plurality of support members is adapted to retain the spool leaf strip on the spool member (not shown). The hot air blower device (not shown) is adapted to blow hot air to the leaf strip to enable the elongated roller member (R) to be retained in the rolled position when the leaf strip is feed to the elongated fixture member (R) by the leaf strip spooling device.

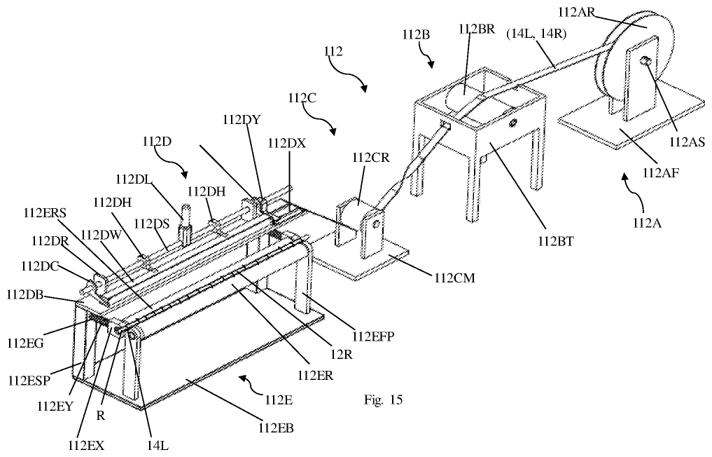

FIG. 15 depicts a perspective view of an add-on leaf strip attaching system (112), according to the embodiments as disclosed herein. In an embodiment, the add-on leaf strip attaching system (112) is adapted to facilitate attaching of each add-on leaf strip (14L, 14R) onto the elongated rolled member (12R), as shown in FIG. 15) thereby facilitating formation of the multi-layered bio-degradable food handling device (10). In an embodiment, the add-on leaf strip attaching system (112) includes an add-on leaf strip spooling device (112A), a hot air blower device (not shown), a bonding agent applying device (112B), at least one add-on leaf strip feeding device (112C), an add-on leaf strip cutting device (112D) and an add-on leaf strip attaching device (112E).

The add-on leaf strip spooling device (112A) is adapted to wind the add-on leaf strip (14L, 14R) of continuous length to facilitate formation of spool add-on leaf strips. To obtain add-on leaf strip of continuous length, one end of the add-on leaf strip is attached to corresponding end of another add-on leaf strip by using the bonding agent and similarly, the plurality of add-on leaf strips (14L, 14R) are attached in the same manner to facilitate formation the add-on leaf strips (14L, 14R) of continuous length. The add-on leaf strip spooling device (112A) is adapted to feed the add-on leaf strip to the bonding agent applying device (112B). The add-on leaf strip spooling device (112A) includes a spool member (112AS), a plurality of support members (112AR) and a main frame (112AF), as shown in FIG. 15). The spool member (112AS) is adapted to hold the spool leaf strips. Each support member (112AR) is connected on corresponding each side of the spool member (112AS). The plurality of support members (112AR) is adapted to retain the spool leaf strip on the spool member (112AS). The spool member (112AS) is freely rotating on the main frame (112AF). The main frame (112AF) is adapted to support the spool member (112AS).

The hot air blower device (not shown) is adapted to blow hot air to the add-on strip (141, 14R) to enable the add-on leaf strip to retain its shape when the add-on leaf strip is feed from the add-on leaf strip spooling device (112A) to the add-on leaf strip cutting device (112D).

The bonding agent applying device (112B) is adapted to apply bonding agent to the scraped abaxial portion of the add-on leaf strip (14L, 14R). In an embodiment, the bonding agent applying device (112B) includes a tank (112BT), a roller (112BR), as shown in FIG. 15) and a driving unit (not shown). The tank (112BT) is adapted to store the bonding agent. The roller (112BR) is adapted to apply the bonding agent onto the scraped abaxial portion of the add-on leaf strip when the roller (112BR) is driven by the driving unit (not shown). The roller (112BR) is supported by the tank (112BT). The roller (112BR) is freely rotating on the tank (112BT). The driving unit (not shown) is adapted to drive the roller (112BR). For the purpose of this description and ease of understanding, the driving unit (not shown) is considered to be an electric motor with a speed reduction gearbox. However, it is also within the scope of the invention to consider the driving unit (not shown) as any of a pneumatic motor, a hydraulic motor, any other rotating mechanism, powered driving means and mechanical driving means and accordingly the speed multiplication gearbox or speed reduction gearbox can be used based on the type of driving unit without otherwise deterring the intended function of the driving unit (not shown) of the bonding agent applying device (112B) as can be deduced from the description and corresponding drawings. The bonding agent applied on the abaxial portion of the ad-on leaf strip is feed to the add-on leaf strip feeding device (112C).

The add-on leaf strip feeding device (112C) is adapted to feed the add-on leaf strip (14L, 14R) to the add-on leaf strip cutting device (112D). In an embodiment, the add-on leaf strip feeding device (112C) includes a roller (112CR) and a main frame (112CM), as shown in FIG. 15). The roller (112CR) is adapted to feed the add-on leaf strip to the add-on leaf strip cutting device (112D). The roller (112CR) is supported by the main frame (112CM). The roller (112CR) is freely rotating on the main frame (112CM). In one embodiment, the roller (112CR) is manually rotated by pulling the add-on leaf strip. In another embodiment, the add-on leaf strip feeding device (112C) includes a driving unit (not shown) adapted to drive the roller (112CR). For the purpose of this description and ease of understanding, the driving unit (not shown) is considered to be an electric motor with a speed reduction gearbox. However, it is also within the scope of the invention to consider the driving unit (not shown) as any of a pneumatic motor, a hydraulic motor, any other rotating mechanism, powered driving means and mechanical driving means and accordingly the speed multiplication gearbox or speed reduction gearbox can be used based on the type of driving unit without otherwise deterring the intended function of the driving unit (not shown) of the add-on leaf strip feeding device (112C) as can be deduced from the description and corresponding drawings.

The add-on leaf strip cutting device (112D) is adapted to cut the add-on leaf strip (14L, 14R) of required length from the spool add-on leaf strip which is being feed by the add-on leaf strip feeding device (112C) to add-on leaf strip cutting device (112D. The add-on leaf strip cutting device (112D) includes a base (112DB), a work top (112DW), as shown in FIG. 15), a shaft (112DS), a shaft lever (112DL), a plurality of shaft support members (112DR), an add-on leaf strip resting member (112DX), as shown in FIG. 15), at least one first holding member (112DY), a plurality of second holding members (112DH) and a plurality of cutting element (112DC), as shown in FIG. 15). The base (112DB) of the add-on leaf strip cutting device (112D) is mounted onto corresponding pillars (112EP) of the add-on leaf strip attaching device (112E). The work top (112DW) is provided on the base (112DB) in front of the shaft support members (112DR). The work top (112DW) is adapted to provide a working surface for the add-on leaf strip during cutting of the add-on leaf strip of required length from the spool add-on leaf strip. The shaft (112DS) is adapted to mount the first holding member (112DY), the plurality of second holding members (112DH) and the plurality of cutting elements (112DC). The shaft (112DS) is freely rotating on the shaft support members (112DR). The shaft (112DS) is supported by the shaft support members (112DS). The add-on leaf strip resting member (112DX) is adapted to provide a resting surface in which one end of the spool add-on leaf strip is laid thereon. The shaft lever (112DL) is adapted to rotate the shaft (112DS) thereby moving the first holding member (112DY) and the plurality of second holding members (112DH) and the plurality of cutting elements (112DC) towards the add-on leaf strip laid on the add-on leaf strip resting member (112DX) and the work top (112DW) respectively. One end of the shaft lever (112DL) is connected to the shaft (112DS). The shaft lever (112DL) is in between the second holding members (112DH). The plurality of shaft support members (112DR) is adapted to support the shaft (112DS). Each shaft support member (112DR) is mounted onto the base (112DB). Each shaft support member (112DR) is spaced away from the other shaft support member (112DR). The first holding member (112DY) is adapted to hold one end of the spool add-on leaf strip which is laid on the add-on leaf strip resting member (112DX). The first holding member (112DY) is mounted on the shaft (112DS) in vicinity of the add-on leaf strip resting member (112DX). The plurality of second holding members (112DH) is adapted to hold the add-on leaf strip laid on the work top (112DW) during cutting of add-on leaf strip of required length from the spool add-on leaf strip feed to the add-on leaf strip cutting device (112D). The plurality of second holding members (112DH) is mounted onto the shaft (112DS) in vicinity of the work top (112DW) and in between the shaft support members (112DR). The plurality of cutting element (112DC) is adapted to cut the add-on leaf strip of required length from the spool add-on leaf strip feed to the add-on leaf strip cutting device (112D). Each cutting element (112DC) is mounted on the shaft (112DS) in vicinity of corresponding end of the work top (112DW). Each cutting element (112DC) is considered to be a cutting blade.

The add-on leaf strip attaching device (112E) is adapted to facilitate attaching of each add-on leaf strip (14L, 14R) onto the elongated rolled member (12R) thereby facilitating formation of the multi-layered bio-degradable food handling device (10). The add-on leaf strip attaching device (112E) includes a fixed roller (112ER), as shown in FIG. 15), a spring loaded roller (112ERS), a plurality of first pillars (112EFP), a plurality of second pillars (112ESP), only one of which is shown in FIG. 15), a base (112EB), a plurality of guide members (112EG), only one of which is shown in FIG. 15), a plurality of roller support members (112EX), only one of which is shown in FIG. 15) and a plurality of springs (112EY), only one of which is shown in FIG. 15). One end of the fixed roller (112ER) is fixedly connected to corresponding first pillar (112EFP) and another end of the fixed roller (112ER) is fixedly connected to corresponding another first pillar (112EFP). The spring loaded roller (112ERS) is loaded onto the plurality of second pillars (112ESP) through the plurality of guide members (112EG), the plurality of roller support members (112EX) and the plurality of springs (112EY). One end of the spring loaded roller (112ERS) is fixedly connected to corresponding roller support member (112EX) and another end of the spring loaded roller (112ERS) is fixedly connected to the another roller support member (112EX). One end of each guide member (112EG) is connected to corresponding second pillar (112ESP) and another end of each guide member (112EG) is connected to corresponding each roller support member (112X). One end of each spring (112EY) is engaged with corresponding each second pillar (110ESP) and another end of each spring (112EY) is engaged with corresponding each roller support member (112EX). The fixed roller (112ER) and the spring loaded roller (112ERS) is adapted to facilitate attaching of each add-on leaf strip (14L, 14R) onto the elongated rolled member (12R) thereby facilitating formation of the multi-layered bio-degradable food handling device (10).

The adaxial portion of the add-on leaf strip (14L) is placed on and in between the fixed roller (112ER) and the spring loaded roller (112ERS) such that the bonding agent applied on the scraped abaxial portion of the add-on leaf strip (14L) is facing upwards. The elongated fixture member (R) along with the elongated rolled member (12R) is pressed onto the add-on leaf strip (14L) against said roller (112ER) and said spring loaded roller (112ERS) such that the fixed roller (112ER) and the spring loaded roller (112ESP) facilitates attaching of the add-on strip onto one side of the elongated rolled member (12R).

Similarly, the adaxial portion of the add-on leaf strip (14R) is placed on and in between the fixed roller (112ER) and the spring loaded roller (112ERS) such that the bonding agent applied on the abaxial portion of the add-on leaf strip (14R) is facing upwards. The elongated fixture member (R) along another side of with the elongated rolled member (12R) is pressed onto another add-on leaf strip (14R) against said roller (112ER) and said spring loaded roller (112ERS) such that the fixed roller (1112ER) and the spring loaded roller (112ESP) facilitates in attaching of the add-on leaf strip (14R) onto another side of the elongated rolled member (12R) thereby forming facilitating formation of the multi-layered bio-degradable food handling device (10) such that the longitudinal edge portions of each add-on leaf strip (14L) overlaps with corresponding edge portions of another add-on leaf strip (14R). Therefore, the elongated fixture member (R) is removed from the multi-layered bio-degradable food handling device (10) after curing of the bonding agent in the abaxial portion of the add-on leaf strip (14L, 14R) of the multi-layered food handling device (10).

The cutting system (114) is adapted to cut the bio-degradable food handling device (10) into a plurality of bio-degradable food handling devices (10), where each bio-degradable food handling devices (10) is of equal length.

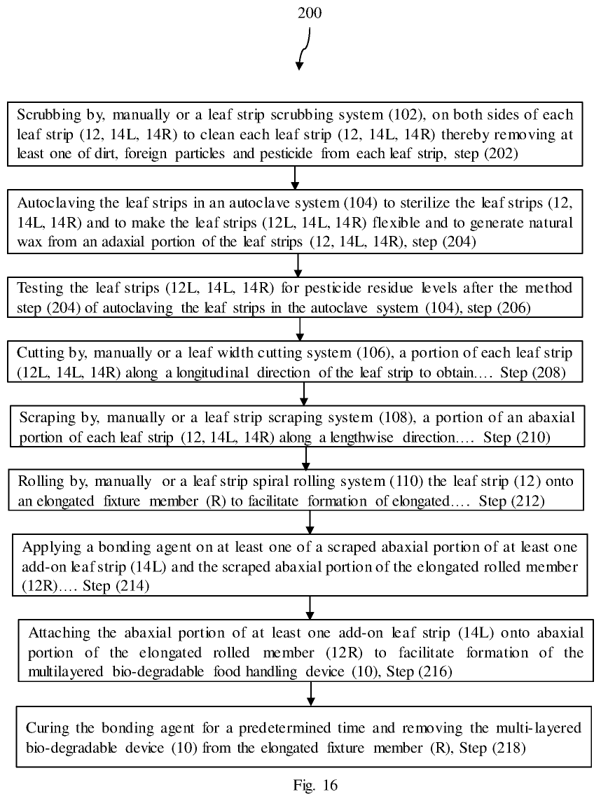

FIG. 16 depicts a flowchart indicating a method (200) for making a multi-layered bio-degradable food handling device (10), according to embodiments as disclosed herein. For the purpose of this description and ease of understanding, the method (200) is explained herein below with reference to making the multi-layered bio-degradable food handling device (10) for use as but not limited a drinking straw, a stirrer, a chopstick, a balloon stick and a candy stick. However, it is also within the scope of this invention to practice/implement the entire steps of the method (200) in a same manner or in a different manner or with omission of at least one step to the method (200) or with any addition of at least one step to the method (200) for making the multilayered bio-degradable food handling device (10) for handling any other types of eatables, dairy based foods and any other types of foods without otherwise deterring the intended function of the method (200) as can be deduced from the description and corresponding drawings. In an embodiment, the method (200) includes, scrubbing by, manually or a leaf strip scrubbing system (102), on both sides of each leaf strip to clean each leaf strip thereby removing at least one of dirt, foreign particles and pesticide from each leaf strip, step (202).

At step (204), the method (200) includes autoclaving the leaf strips (12, 14L, 14R) in an autoclave system (104) to sterilize the leaf strips and to make the leaf strips (12, 14L, 14R) flexible and to generate natural wax from an adaxial portion of the leaf strips.

At step (206), the method (200) includes testing the leaf strips (12, 14L, 14R) for pesticide residue levels after the method step (204) of autoclaving the leaf strips in the autoclave system (104).

At step (208), the method (200) includes cutting a portion of each leaf strip (12, 14L, 14R) along a longitudinal direction of the leaf strip to obtain each leaf strip (12, 14L, 14R) with a predefined width.

At step (210), the method (200) includes scraping a portion of an abaxial portion of each leaf strip (12, 14L, 14R) along a lengthwise direction of the leaf strip.

At step (212), the method (200) includes rolling the leaf strip (12) onto an elongated fixture member (R) to facilitate formation of elongated rolled member (12R).

At step (214), the method (200) includes applying a bonding agent on at least one of a scraped abaxial portion of at least one add-on leaf strip (14L, 14R) and the scraped abaxial portion of the elongated rolled member (12R).

At step (216) the method (200) includes attaching the abaxial portion of at least one add-on leaf strip (14L, 14R) onto abaxial portion of the elongated rolled member (12R) to facilitate formation of the multilayered bio-degradable food handling device (10).

At step (218) the method (200) includes curing the bonding agent for a predetermined time and removing the multi-layered bio-degradable device (10) from the elongated fixture member (R).

At step (220), the method (200) includes cutting by, manually or a cutting system (114), the multi-layered bio-degradable device (10) into a plurality of bio-degradable devices, where each bio-degradable device is of equal length.

The method (200) includes separating a midrib from each leaf strip, step (201A) prior to method step (202) of scrubbing by, manually or a leaf strip scrubbing system (102), on both sides of each leaf strip to clean each leaf strip thereby removing at least one of dirt, foreign particles and pesticide from each leaf strip.

The method (200) includes soaking the leaf strips in at least one of a cold water and a normal water, step (201B) after the method step (201A) of separating the midrib from each leaf strip.

The method step (208) of cutting the portion of each leaf strip along the longitudinal direction of the leaf strip to obtain each leaf strip with the predefined width by at least one of,

manually cutting the portion of each leaf strip (12, 14L, 14R) by using a cutting device along the longitudinal direction of the leaf strip to obtain each leaf strip with the predefined width and

cutting by, the leaf strip width cutting system (106), the portion of each leaf strip (12, 14L, 14R) along the longitudinal direction of the leaf strip to obtain each leaf strip with the predefined width.

The method step of cutting the portion of each leaf strip (12, 14L, 14R) by the leaf strip width cutting system (106), includes

driving a shaft (106DS) of a driving roller assembly (106D) by a driving unit (106M);

driving a driven gear of a driven roller assembly (106R) by a driving gear of the driving roller assembly (106D);

guiding each leaf strip to and in between a plurality of spacers (106DSR) of the driving roller assembly (106D) and a roller (106RR) of the driven roller assembly (106R) by a leaf strip guiding unit (106G);

feeding each leaf strip (12, 14L, 14R) to at least one cutting element (106DC) of the driving roller assembly (106D) by the plurality of spacers (106DSR) of the driving roller assembly (106D) and the roller (106RR) of the driven roller assembly (106R); and

cutting by at least one cutting element (106DC), portion of each leaf strip (12, 14L, 14R) along longitudinal direction of the leaf strip to obtain each leaf strip with the predefined width.

The method step (210) of scraping the portion of the abaxial portion of each leaf strip (12, 14L, 14R) by at least one of,

manually scraping the portion of the abaxial portion of each leaf strip by rubbing an abrasive sheet on the abaxial portion of each leaf strip; and

scraping by, a leaf strip scraping system (108), the portion of the abaxial portion of each leaf strip (12, 14L, 14R).

Scraping the abaxial portion of the leaf strip (12, 14L, 14R) by the leaf strip scraping system (108) includes,

driving a shaft (108DS) of a driving roller assembly (108D) by a driving unit (108M) of a leaf strip feeding device (108A);

driving a driven gear of a driven roller assembly (108R) by a driving gear of the driving roller assembly (108D) of the leaf strip feeding device (108A);

guiding by, leaf strip guiding unit (108G), each leaf strip (12, 14L, 14R) to and in between a roller (108DSR) of the driving roller assembly (108D) and a roller (108RR) of the driven roller assembly (108R) of the leaf strip feeding device (108A);

feeding each leaf strip (12, 14L, 14R) to an abrasive belt (108BB) of a leaf strip scraping device (108B) by the roller (108DSR) of the driving roller assembly (108D) and the roller (108RR) of the driven roller assembly (108R) of the leaf strip feeding device (108A);

and scraping by, the abrasive belt (108BB), the portion of the abaxial portion of each leaf strip (12, 14L, 14R) when a shaft (108BFX) of a first roller assembly (108BFR) is driven by a driving unit (108BM) of the leaf strip scraping device (108B), where the abrasive belt (108BB) is provided on a roller (108BFY) of the first roller assembly (108BFR) and a roller (108BSY) of a second roller assembly (108BSR)

The method step (212) of rolling the leaf strip onto the elongated fixture member (R) to facilitate formation of elongated rolled member (12R) by at least one of,

manually rolling the leaf strip (12) onto the elongated fixture member (R) to facilitate formation of elongated rolled member (12R), and

rolling, by a leaf strip (12) spiral rolling device (110A), the leaf strip onto the elongated fixture member (R) to facilitate formation of elongated rolled member (12R).

The rolling the leaf strip (12) onto the elongated fixture member (R) by the leaf strip spiral rolling device (110A) includes,

engaging one end of the elongated fixture member (R) to a live center (110ATC) of a tailstock assembly (110AT) and engaging another end of the elongated fixture member (R) to an output shaft of a driving unit (110AM) of the leaf strip spiral rolling device (110A);

feeding one end of leaf strip (12) onto the elongated fixture member (R);

blowing hot air onto the leaf strip (12) by a hot air blowing device;

rotating the elongated fixture member (R) by the driving unit (110AM) to facilitate formation of elongated rolled member (12R);

retaining the elongated rolled member (12R) in a spiral rolled position by at least one of engaging holding members on both ends of the elongated rolled member (R) and applying a bonding agent on at least a portion of the leaf strip (12); and

removing the elongated fixture member (R) from the live center (110ATC) of the tail stock assembly (110AT) and the output shaft of the driving unit (110AM).

The method step (214) of applying a bonding agent on at least one of a scraped abaxial portion of at least one add-on leaf strip (14L, 14R) and the scraped abaxial portion of the elongated rolled member (12R) by at least one of,

manually applying a bonding agent on at least one of a scraped abaxial portion of at least one add-on leaf strip (14L, 14R) and the scraped abaxial portion of the elongated rolled member (12R); and

applying by, an add-on leaf strip attaching system (112), a bonding agent on at least one of a scraped abaxial portion of at least one add-on leaf strip (14L, 14R) and the scraped abaxial portion of the elongated rolled member (12R).

Applying the bonding agent by the add-on leaf strip attaching system (112), includes

feeding by, an add-on leaf strip spooling device (112A), the add-on leaf strip (14L, 14R) to a bonding agent applying device (112B);

applying by, a roller (112BR) of the bonding agent applying device (112B), bonding agent to the scraped abaxial portion of the add-on leaf strip (14L, 14R), where the roller (112BR) is provided in a tank (112Bt) which stores the bonding agent;

feeding by, a roller (112CR) of an add-on leaf strip feeding device (112C), the add-on leaf strip (14L, 14R) from the bonding agent applying device (112B) to an add-on leaf strip cutting device (112D);

blowing hot air to the add-on leaf strip (14L, 14R) by a hot air blowing device; and

cutting by, the add-on leaf strip cutting device (112D), the add-on leaf strip (14L, 14R) of required length from the spool add-on leaf strip

The method step (216) attaching the abaxial portion of at least one add-on leaf strip onto abaxial portion of the elongated rolled member (12R) to facilitate formation of the multilayered bio-degradable food handling device (10) by at least one of,

manually attaching the add-on leaf strip (14L, 14R) on the elongated rolled member (12R) to facilitate formation of the multilayered bio-degradable food handling device (10); and

attaching by, an add-on leaf strip attaching device (112E), the abaxial portion of at least one add-on leaf strip (14L, 14R) onto abaxial portion of the elongated rolled member (12R) to facilitate formation of the multilayered bio-degradable food handling device (10).

Attaching the add-on leaf strip (14L, 14R) onto the elongated rolled member (R) by the add-on leaf strip attaching device (112E) includes,

placing the adaxial portion of the add-on leaf strip (14L, 14R) on and in between a fixed roller (fixed roller (112ER) and a spring loaded roller (112ERS) of the add-on leaf strip attaching device (112E) such that the bonding agent applied on the abaxial portion of the add-on leaf strip (14L, 14R) is facing upwards; and

attaching, by the fixed roller (112ER) and the spring loaded roller (112ERS), the add-on leaf strip (14L, 14R) onto the elongated rolled member (R) thereby facilitating formation of the multilayered bio-degradable food handling device (10) by pressing the elongated rolled member (12R) along with the elongated fixture member (R) on the add-on leaf strip (14L, 14R) against said roller (112ER) and said spring loaded roller (112ERS).

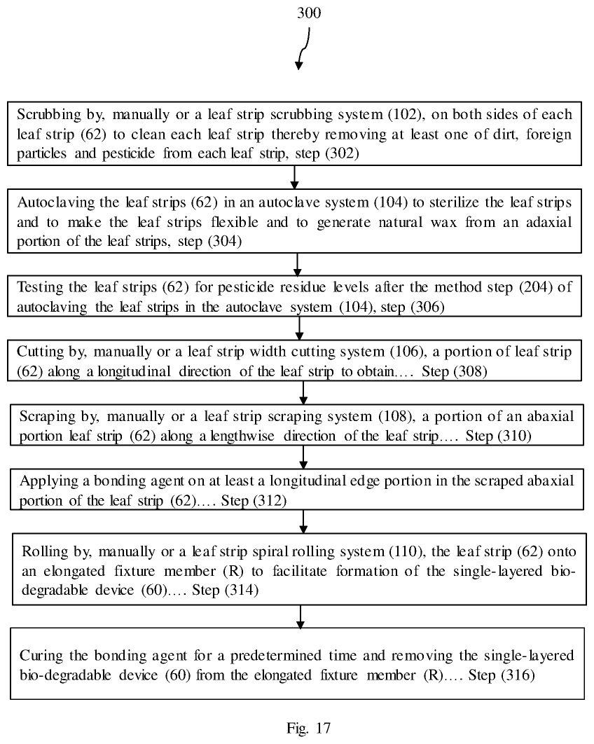

FIG. 17 depicts a flowchart indicating a method (300) for making a single-layered bio-degradable food handling device (10), according to embodiments as disclosed herein. For the purpose of this description and ease of understanding, the method (300) is explained herein below with reference to making the single-layered bio-degradable food handling device (10) for use as but not limited a drinking straw, a stirrer, a chopstick, a balloon stick and a candy stick. However, it is also within the scope of this invention to practice/implement the entire steps of the method (300) in a same manner or in a different manner or with omission of at least one step to the method (300) or with any addition of at least one step to the method (300) for making the multilayered bio-degradable food handling device (10) for handling any other types of eatables, dairy based foods and any other types of foods without otherwise deterring the intended function of the method (300) as can be deduced from the description and corresponding drawings. In an embodiment, the method (300) includes, scrubbing by, manually or a leaf strip scrubbing system (102), on both sides of each leaf strip to clean each leaf strip thereby removing at least one of dirt, foreign particles and pesticide from each leaf strip, step (302).

At step (304), the method (300) includes autoclaving the leaf (62) strips in an autoclave system (104) to sterilize the leaf strips (62) and to make the leaf strips flexible and to generate natural wax from an adaxial portion of the leaf strips, step (304).

At step (306), the method (300) includes testing the leaf strips (62) for pesticide residue levels after the method step (304) of autoclaving the leaf strips in the autoclave system (104).

At step (308), the method (300) includes cutting by, manually or a leaf strip width cutting system (106), a portion of each leaf strip (62) along a longitudinal direction of the leaf strip to obtain each leaf strip (62) with a predefined width.

At step (310), the method (300) includes scraping by, manually or a leaf strip scraping system (108), a portion of an abaxial portion of each leaf strip (62).

At step (312), the method (300) includes applying a bonding agent on at least a longitudinal edge portion in the scraped abaxial portion of the leaf strip (62).

At step (314), the method (300) includes rolling by, manually or a leaf strip spiral rolling system (110), the leaf strip (62) onto an elongated fixture member (R) to facilitate formation of the single-layered bio-degradable device (60).

At step (316) the method (300) includes curing the bonding agent for a predetermined time and removing the single-layered bio-degradable device from the elongated fixture member (R).

At step (318), the method (300) includes cutting by, manually or a cutting system (114), the single-layered bio-degradable device into a plurality of bio-degradable devices, where each bio-degradable device is of equal length.

The method (300) includes separating a midrib from each leaf strip, step (301A) prior to method step (302) of scrubbing by, manually or a leaf strip scrubbing system (102), on both sides of each leaf strip (62) to clean each leaf strip thereby removing at least one of dirt, foreign particles and pesticide from each leaf strip.

The method (300) includes soaking the leaf strips (62) in at least one of a cold water and a normal water, step (301B) after the method step (301A) of separating the midrib from each leaf strip.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of embodiments, those skilled in the art will recognize that the embodiments herein can be practiced with modifications within the spirit and scope of the embodiments as described herein.

We claim:

1. A bio-degradable food handling device (10, 20, 30) comprising:
a main leaf strip (12, 22, 32) adapted to be rolled on an elongated fixture member (R) to facilitate formation of an elongated rolled member (12R, 22R, 32R); and
at least one add-on leaf strip assembly (14, 24, 34) adapted to be attached to said elongated rolled member (12R, 24R, 34R) thereby facilitating formation of said bio-degradable food handling device (10, 20, 30).

2. The bio-degradable food handling device (10) as claimed in claim 1, wherein said main leaf strip (12) defines an adaxial portion (12X) and an abaxial portion (12Y);
said add-on leaf strip assembly (14) includes a plurality of add-on leaf strips (14L, 14R), where each of said add-on leaf strip (14L, 14R) defines an adaxial portion (14LX, 14RX) and an abaxial portion (14LY, 14RY);
said main leaf strip (12) and each of said add-on leaf strip (14L, 14R) is made from at least one of a plant leaf and a tree leaf, where the tree leaf is a coconut tree leaf or a palm tree leaf;
at least one of the abaxial portion (12Y) of said main leaf strip (12) and the abaxial portion (14LY, 14RY) of each of said add-on leaf strip (14) is scraped;
the scraped abaxial portion (12Y) of said main leaf strip (12) becomes scraped abaxial portion (12Y) of said elongated rolled member (12R) in the rolled position;
a bonding agent is applied on at least one of the scraped abaxial portion (12Y) of said elongated rolled member (12R) and the scraped abaxial portion (14LY, 14RY) of each of said add-on leaf strip (14L, 14R) to attach each of said add-on leaf strip (14L, 14R) onto corresponding side of said elongated rolled member (12R) in which both longitudinal end portions of said add-on leaf strip (14L) overlap with corresponding longitudinal end portions of another said add-on leaf strip (14R) thereby facilitating formation of the bio-degradable food handling device (10);
said bio-degradable food handling device (10) is removed from the elongated fixture member (R) after curing of the bonding agent;
said bio-degradable food handling device (10) is a multi-layered bio-degradable food handling device in which said main leaf strip (12) forms a first layer and each of said add-on leaf strip (14L, 14R) forms a second layer; and
an inner portion (10X) and an outer portion (10Y) of the bio-degradable food handling device (10) is the adaxial portion (12X) of said main leaf strip (12) and the adaxial portion (14LX, 14RX) of said add-on leaf strips (14L, 14RY) respectively.

3. The bio-degradable food handling device (20) as claimed in claim 1, wherein said main leaf strip (22) defines an adaxial portion (22X) and an abaxial portion (22Y);
said add-on leaf strip assembly (24) includes an add-on leaf strip (24L), where said add-on leaf strip (24L) defines an adaxial portion (24LX) and an abaxial portion (24LY);
said main leaf strip (22) and said add-on leaf strip (24L) is made from at least one of a plant leaf and a tree leaf, where the tree leaf is a coconut tree leaf or a palm tree leaf;
at least one of the abaxial portion (22Y) of said main leaf strip (22) and the abaxial portion (24LY) of said add-on leaf strip (24L) is scraped;
the scraped abaxial portion (22Y) of said main leaf strip (22) becomes scraped abaxial portion (22Y) of said elongated rolled member (22R) in the rolled position;
a bonding agent is applied on at least one of the scraped abaxial portion (22Y) of said elongated rolled member (22R) and the scraped abaxial portion (24LY) of said add-on leaf strip (24L) to attach said add-on leaf strip (24L) onto said elongated rolled member (22R) thereby facilitating formation of the bio-degradable food handling device (20);
said bio-degradable food handling device (20) is removed from the elongated fixture member (R) after curing of the bonding agent;
said bio-degradable food handling device (20) is a multi-layered bio-degradable food handling device in which said main leaf strip (22) forms a first layer and said add-on leaf strip (24L) forms a second layer; and
an inner portion (20X) and an outer portion (20Y) of the bio-degradable food handling device (20) is the adaxial portion (22X) of said main leaf strip (22) and the adaxial portion (24LX) of said add-on leaf strip (24L) respectively.

4. The bio-degradable food handling device (30) as claimed in claim 1, wherein said main leaf strip (32) defines an adaxial portion (32X) and an abaxial portion (32Y);
said add-on leaf strip assembly (34) includes an add-on leaf section (34A) and at least one add-on leaf strip (34B), where said add-on leaf section (34A) includes a midrib (34AR) and a leaf portion (34AL) extending on both sides of the midrib (34AR), where said leaf portion (34AL) defines an adaxial portion (34ALX) and an abaxial portion (34ALY), where said add-on leaf strip (34B) defines an adaxial portion (34BX) and an abaxial portion (34BY);
said main leaf strip (32), said add-on leaf section (34A) and said at least one add-on leaf strip (34B) are made from at least one of a plant leaf and a tree leaf, where the tree leaf is a coconut tree leaf or a palm tree leaf;
at least one of the abaxial portion (32Y) of said main leaf strip (32), the abaxial portion (34ALY) of the leaf portion (34AL) of said add-on leaf section (34A) and the abaxial portion (34BY) of said add-on leaf strip (34B) is scraped;
the scraped abaxial portion (32Y) of said main leaf strip (32) becomes scraped abaxial portion (32Y) of said elongated rolled member (32R) in the rolled position;
a bonding agent is applied on at least one of the scraped abaxial portion (32Y) of said elongated rolled member (32R) and the scraped abaxial portion (24ALY) of the leaf portion (34AL) of said add-on leaf section (34A) to attach said add-on leaf section (34A) onto said elongated rolled member (32R);
the bonding agent is applied on the scraped abaxial portion (34BY) of said add-on leaf strip (34B) to attach said add-on leaf strip (34B) onto at least one of said add-on leaf section (34A) and the elongated rolled member (32R) thereby facilitating formation of the bio-degradable food handling device (30);
said add-on leaf section (34A) is sandwiched in between said elongated rolled member (32R) and said add-on leaf strip (34B);
said bio-degradable food handling device (30) is removed from the elongated fixture member (R) after curing of the bonding agent;
said bio-degradable food handling device (30) is a multi-layered bio-degradable food handling device in which said main leaf strip (32) forms a first layer and said add-on leaf section (34A) forms a second layer and said add-on leaf strip (34B) forms a third layer; and
an inner portion (30X) and an outer portion (30Y) of the bio-degradable food handling device (30) is the adaxial portion (32X) of said main leaf strip (32) and the adaxial portion (34BX) of said add-on leaf strip (34B) respectively.

5. The bio-degradable food handling device (10, 20, 30) as claimed in claim 1,
said elongated rolled member (12R, 22R, 32R) is retained in a rolled position on the elongated fixture member (R) by at least one of engaging holding members on both ends of the elongated rolled member (12R, 22R, 32R) blowing hot air to the main leaf strip (12, 22, 32) and applying a bonding agent on at least a portion of said main leaf strip (12, 22, 32); and
the holding members are removed after attachment of the add-on leaf strip assembly (14, 24, 34) on to said elongated rolled member (12R, 24R, 34R); and
said multi-layered bio-degradable food handling device (10, 20, 30) is removed from the elongated fixture member (R).

6. The bio-degradable food handling device (10) as claimed in claim 1, wherein said bio-degradable food handling device (10, 20, 30) defines a piercing portion adapted to pierce a seal of at least one of a tumbler, a can, a tetra pack and a drinkable storage can and a food storage pack; and
said bio-degradable food handling device (10) is configured to be used as at least one of a drinking straw, a stirrer, a chopstick, a balloon stick and a candy stick.

7. A bio-degradable food handling device (50) comprising:
a first leaf strip (52) defining an adaxial portion (52X) and an abaxial portion (52Y); and
at least one second leaf strip (54) defining a adaxial portion (54X) and an abaxial portion (54Y),
wherein
a bonding agent is applied on at least one of half of the abaxial portion (52Y) of said first leaf strip (52) along a longitudinal direction of said first leaf strip (52) and a half of the abaxial portion (54Y) of said second leaf strip (54) along a longitudinal direction of said second leaf strip (54) to attach said first leaf strip (52) onto said second leaf strip (54) in which half of the abaxial portion (52Y) of said first leaf strip (52) is overlapped onto half of the abaxial portion (54Y) of said second leaf strip (54) thereby facilitating formation of an overlapped first and second leaf strip (52, 54); and
said overlapped first and second leaf strip (52, 54) is spiral rolled onto an elongated fixture member (R) to facilitate formation of said bio-degradable food handling device (50).

8. The bio-degradable food handling device (50) as claimed in claim 7, wherein said first leaf strip (52) and said second leaf strip (54) is made from at least one of a plant leaf and a tree leaf, where the tree leaf is a coconut tree leaf or a palm tree leaf;
the abaxial portion (52Y) of said first leaf strip (52) and the abaxial portion (54Y) of said second leaf strip (54) are scraped;
the bonding agent is applied on a longitudinal edge portion of said overlapped first and second leaf strip (52, 54) to attach the longitudinal edge portion with corresponding portion of said overlapped first and second leaf strip (52, 54) thereby facilitating formation of said bio-degradable food handling device (50) when said overlapped first and second leaf strip (52, 54) is spiral rolled on the elongated fixture member (R);
said bio-degradable food handling device (50) is removed from the elongated fixture member (R) after curing of the bonding agent;
said bio-degradable food handling device (50) is configured to be used as at least one of a drinking straw, a stirrer, a chopstick, a balloon stick and a candy stick; and
said bio-degradable food handling device (50) defines a piercing portion adapted to pierce a seal of at least one of a tumbler, a can, a tetra pack and a drinkable storage can and a food storage pack.

9. A bio-degradable food handling device (40) comprising:
a first leaf strip (42) defining an adaxial portion and an abaxial portion; and
at least one add-on leaf strip (44) defining an adaxial portion and an abaxial portion, wherein
the abaxial portion of said first leaf strip (42) and the abaxial portion of said at least one add-on leaf strip (44) are scraped;
a bonding agent is applied on at least a longitudinal edge portion of the abaxial portion of said first leaf strip (42) to attach the longitudinal edge portion with corresponding portion of said first strip (42) when said first leaf strip (42) is adapted to be spiral rolled onto an elongated fixture member (R) to facilitate formation of an elongated rolled member (42R);
a bonding agent is applied on at least one of the scraped abaxial portion of said add-on leaf strip (44) and the scraped abaxial portion of the elongated rolled member (42R);
the abaxial portion of said at least one add-on leaf strip (44) is spiral rolled onto the abaxial portion of said elongated rolled member (42R) to attach said at least one add-on leaf strip (44) onto said elongated rolled member (42R) thereby facilitating formation of said bio-degradable food handling device (40);
said bio-degradable food handling device (40) is removed from the elongated fixture member (R) after curing of bonding agent; and
said bio-degradable food handling device (40) is configured to be used as at least one of a drinking straw, a stirrer, a chopstick, a balloon stick and a candy stick.

10. A system (100) for making a multi-layered bio-degradable food handling device (10), said system (100) comprising:
a leaf strip width cutting system (106) adapted to cut a portion of at least one leaf strip (12) along a longitudinal direction of the leaf strip to obtain the leaf strip with a predefined width;
a leaf strip scraping system (108) adapted to scrape an abaxial portion of the leaf strip (12);
a leaf strip spiral rolling system (110) adapted to spiral roll the leaf strip (12) on an elongated fixture member (R) to facilitate formation of an elongated rolled member (12R); and
an add-on leaf strip attaching system (112) adapted to facilitate attaching of at least one add-on leaf strip (14L, 14R) onto the elongated rolled member (12R) thereby facilitating formation of the multi-layered bio-degradable food handling device (10).

11. The system (100) as claimed in claim 10, wherein said system (100) comprises,
a leaf strip scrubbing system (102) adapted to scrub an adaxial portion of the leaf strips (12, 14L, 14R) to remove at least one of dirt, foreign particles and pesticide from the leaf strips thereby cleaning the leaf strips; and
an autoclave system (104) adapted to sterilize the leaf strips (12, 14L, 14R), where said autoclave system (104) is adapted to at least one of make the leaf strips flexible and generate natural wax from the adaxial portion of the leaf strips.

12. The system (100) as claimed in claim 10, wherein said leaf strip width cutting system (106) comprises,
a driving roller assembly (106D) comprising a shaft (106DS), a plurality of cutting elements (106DC), a plurality of spacers (106DSR) and a driving gear;
a driving unit (106M) adapted to drive said shaft (106DS) of said driving roller assembly (106D);
a driven roller assembly (106R) comprising a shaft (106RT), a roller (106RR) and a driven gear, where said driven gear is driven by said driving gear of said driving roller assembly (106D); and
a leaf strip guiding unit (106G) is adapted to guide the leaf strips in between said spacers (106DSR) of said driving roller assembly (106D) and said roller (106RR) of said driven roller assembly (106R),
wherein
said plurality of spacers (106DSR) and said roller (106RR) are adapted to feed the lead strip (12, 14L, 14R) to at least one said cutting element (106DC); and
at least one said cutting element (106DC) is adapted to cut a portion of the leaf strip (12, 14L, 14R) along a longitudinal direction of the leaf strip to obtain the leaf strip (12, 14L, 14R) with a predefined width.

13. The system (100) as claimed in claim 10, wherein said leaf strip scraping system (108) comprises a leaf strip feeding device (108A), a leaf strip scraping device (108B) and a leaf strip scraping setting device (108BGS),
wherein said leaf strip feeding device (108A) comprises,
a driving roller assembly (108D) comprising a shaft (108DS), a roller (108DSR) and a driving gear;
a driving unit (108M) adapted to drive said shaft (108DS) of said driving roller assembly (108D);
a driven roller assembly (108R) comprising a shaft, a roller (108RR) and a driven gear adapted to be driven by said driving gear of said driving roller assembly (108D); and
a leaf strip guiding unit (108G) adapted to guide the leaf strips in between said roller (108DSR) of said driving roller assembly (108D) and said roller (108RR) of said driven roller assembly (108R),
wherein said leaf strip scraping device (108B) comprises,
a first roller assembly (108BFR) comprising a shaft (108BFX) and a roller (108BFY);
a second roller assembly (108BSR) comprising a shaft and a roller (108BSY),
an abrasive belt (108BB) adapted to be provided onto said rollers (108BFY, 108BSY) of said first and second roller assemblies (108BFR, 108BSR); and
a driving unit (108BM) adapted to drive said shaft (108BFX) of said first roller assembly (108BFR),
wherein
said rollers (108DSR, 108RR) of said driving and driven roller assemblies (108D, 108R) of said leaf strip feeding device (108A) are adapted to feed the leaf strips (12, 14L, 14R) to said abrasive belt (108BB);
said abrasive belt (108BB) is adapted to scrape an abaxial portion of the leaf strips (12, 14L, 14R); and
said leaf strip scraping setting device (108BGS) is adapted to guide the leaf strip (12, 14L, 14R) onto said abrasive belt (108BB) and set amount of scraping on the leaf strip.

14. The system (100) as claimed in claim 10, wherein said leaf strip spiral rolling system (110) comprises,
a leaf strip spiral rolling device (110A) comprising a driving unit (110AM) and a tail stock assembly (110AT) opposite to said driving unit (110AM),
wherein
the elongated fixture member (R) is adapted to be removably connected to an output shaft of said driving unit (110AM) and a live center (110ATC) of said tail stock assembly (110AT); and
said driving unit (110AM) is adapted to rotate the elongated fixture member (R) to spiral roll the leaf strip (12) onto the elongated fixture member (R) thereby facilitating formation of the elongated rolled member (12R).

15. The system (100) as claimed in claim 14, wherein said leaf strip spiral rolling system (110) comprises,
a leaf strip spooling device adapted to feed the leaf strip (12) to the elongated fixture member (R), where said leaf strip spooling device comprises a spool member adapted to hold the spool leaf strips (12);
a leaf strip guiding device (110B) adapted to guide and move the leaf strip spooling device with respect to the rotation of the elongated fixture member (R) by said driving unit (110AM) of said leaf strip spiral rolling device (110A), where said leaf strip guiding device (110B) comprises a guiding member (110BG) and a movable member (110BS), where said movable member (110BS) is movably connected to said guiding member (110BG), where said movable member (110BS) is adapted to mount said leaf strip spooling device; and
a hot air blower device adapted to blow hot air to the leaf strip (12) when the leaf strip (12) is feed to the elongated fixture member (R) to retain the elongated rolled member (12R) on the elongated fixture member (R) in a rolled position.

16. The system (100) as claimed in claim 15, wherein said leaf strip guiding device (110B) comprises,
a driving unit adapted to rotate said guiding member (110BG) to move said
movable member (110BS) on guiding member (110BG) thereby moving said leaf strip spooling device with respect to rotation of the elongated fixture member (R) by said driving unit (110AM) of said leaf strip spiral rolling device (110A),
wherein
said guiding member (110BG) is a lead screw;
said movable member (110BS) is a nut;
said driving unit of said leaf strip guiding device (110B) is at least an electric motor with a speed reduction gearbox; and
said driving unit (110AM) of said leaf strip spiral rolling device (110A) is at least an electric motor with a speed reduction gearbox.

17. The system (100) as claimed in claim 10, wherein add-on leaf strip attaching system (112) comprises,
an add-on leaf strip spooling device (112A) comprising a spool member (112AS) adapted to hold the spool add-on leaf strips (14L, 14R),
a bonding agent applying device (112B) comprising a tank (112BT), where said tank (112BT) is adapted to store a bonding agent, a roller (112BR), where said roller (112BR) is adapted to apply the bonding agent onto scraped abaxial portion of the add-on leaf strip (14L, 14R) when the add-on leaf strip (14L, 14R) is feed from said add-on leaf strip spooling device (112A) to said roller (112BR);
at least one add-on leaf strip feeding device (112C) comprising a roller (112CR);
an add-on leaf strip cutting device (112D) comprising base (112DB), a shaft (112DS), a work top (112DW), an add-on leaf strip resting member (112DX), at least one first holding member (112DY), where said first holding member (112DY) is adapted to hold one end of the spool add-on leaf strip (14L, 14R) which is laid on the add-on leaf strip resting member (112DX), at least one second holding member (112DH) and a plurality of cutting elements (112DC);
an add-on leaf strip attaching device (112E) comprising a fixed roller (112ER) supported on a plurality of first pillars (112EFP) and a spring loaded roller (112ERS) supported to a plurality of second pillars (112ESP); and
a hot air blower device low hot air to the add-on strip to enable the add-on leaf strip (14L, 14R) to retain its shape when the add-on leaf strip is feed from said add-on leaf strip spooling device (112A) to said add-on leaf strip cutting device (112D),
wherein
said roller (112CR) of said add-on leaf strip feeding device (112C) is adapted to feed the add-on leaf strip (14L, 14R) from said add-on leaf strip spooling device (112A) to said add-on leaf strip cutting device (112D); and
each of said cutting element (112DC) of said add-on leaf strip cutting device (112D) is adapted to cut the add-on leaf strip (14L, 14R) of required length from the spool add-on leaf strip; and
said fixed roller (112ER) and said spring loaded roller (112ERS) of said add-on leaf strip attaching device (112E) is adapted to facilitate attaching of each add-on leaf strip (14L, 14R) onto the elongated rolled member (12R) thereby facilitating formation of the multi-layered bio-degradable food handling device (10) when the elongated rolled member (12R) along with the elongated fixture member (R) is pressed on the add-on leaf strip (14L, 14R) against said roller (112ER) and said spring loaded roller (112ERS).

18. The system (100) as claimed in claim 10, wherein said system (100) comprises a cutting system (114) adapted to cut the bio-degradable food handling device (10) into a plurality of bio-degradable food handling devices (10), where each bio-of said degradable food handling device (10) is of equal length.

19. A method (200) of making a multi-layered bio-degradable food handling device (10), said method (200) comprising:
cutting a portion of each leaf strip (12, 14L, 14R) along a longitudinal direction of the leaf strip (12, 14L, 14R) to obtain each leaf strip with a predefined width;
scraping a portion of an abaxial portion of each leaf strip (12, 14L, 14R) along a lengthwise direction of each leaf strip;
rolling the leaf strip (12) onto an elongated fixture member (R) to facilitate formation of elongated rolled member (12R);
applying a bonding agent on at least one of a scraped abaxial portion of at least one add-on leaf strip (14L, 14R) and the scraped abaxial portion of the elongated rolled member (12R); and
attaching the abaxial portion of at least one add-on leaf strip (14L, 14R) onto abaxial portion of the elongated rolled member (12R) to facilitate formation of the multilayered bio-degradable food handling device (10).

20. The method (200) as claimed in claim 19, wherein said method (200) comprises,
scrubbing by, manually or a leaf strip scrubbing system (102), on both sides of each leaf strip (12, 14L, 14R) to clean each leaf strip thereby removing at least one of dirt, foreign particles and pesticide from each leaf strip; and
autoclaving the leaf strips (12, 14L, 14R) in an autoclave system (104) to sterilize the leaf strips and to make the leaf strips flexible and to generate natural wax from an adaxial portion of the leaf strips after said scrubbing the leaf strips by manually or the leaf strip scrubbing system (102); and
testing the leaf strips (12, 14L, 14R) for pesticide residue levels after said autoclaving the leaf strips in the autoclave system (104).

21. The method (200) as claimed in claim 19, wherein said method (200) comprises,
curing the bonding agent for a predetermined time and removing the multi-layered bio-degradable device (10) from the elongated fixture member (R) after said attaching the scraped abaxial portion of at least one add-on leaf strip (14L, 14R) onto scraped abaxial portion of the elongated rolled member (12R); and
cutting the multi-layered bio-degradable food handling device (10) into a plurality of bio-degradable food handling devices, where each bio-degradable food handling device is of equal length.

22. The method (200) as claimed in claim 19, wherein said cutting the portion of each leaf strip (12, 14L, 14R) along the longitudinal direction of the leaf strip to obtain each leaf strip with a predefined width by at least one of,
manually cutting the portion of each leaf strip (12, 14L, 14R) by using a cutting device along the longitudinal direction of the leaf strip to obtain each leaf strip with the predefined width; and
cutting by, the leaf strip width cutting system (106), the portion of each leaf strip (12, 14L, 14R) along the longitudinal direction of the leaf strip to obtain each leaf strip with the predefined width, wherein cutting the portion of each leaf strip by the leaf strip width cutting system (106), includes,
driving a shaft (106DS) of a driving roller assembly (106D) by a driving unit (106M);
driving a driven gear of a driven roller assembly (106R) by a driving gear of the driving roller assembly (106D);
guiding each leaf strip (12, 141, 14R) to and in between a plurality of spacers (106DSR) of the driving roller assembly (106D) and a roller (106RR) of the driven roller assembly (106R) by a leaf strip guiding unit (106G);
feeding each leaf strip (12, 141, 14R) to at least one cutting element (106DC) of the driving roller assembly (106D) by the plurality of spacers (106DSR) of the driving roller assembly (106D) and the roller (106RR) of the driven roller assembly (106R); and
cutting by at least one cutting element (106DC), portion of each leaf strip (12, 14L, 14R) along longitudinal direction of the leaf strip to obtain each leaf strip with the predefined width.

23. The method (200) as claimed in claim 19, wherein scraping the portion of the abaxial portion of each leaf strip (12, 14L, 14R) by at least one of,
manually scraping the portion of the abaxial portion of each leaf strip (12, 14L, 14R) by rubbing an abrasive sheet on the abaxial portion of each leaf strip (12, 14L, 14R); and
scraping by, a leaf strip scraping system (108), the portion of the abaxial portion of each leaf strip (12, 14L, 14R), wherein scraping the abaxial portion of the leaf strip by the leaf strip scraping system (108) includes,
driving a shaft (108DS) of a driving roller assembly (108D) by a driving unit (108M) of a leaf strip feeding device (108A);
driving a driven gear of a driven roller assembly (108R) by a driving gear of the driving roller assembly (108D) of the leaf strip feeding device (108A);
guiding by, a leaf strip guiding unit (108G), each leaf strip (12, 14L, 14R) to and in between a roller (108DSR) of the driving roller assembly (108D) and a roller (108RR) of the driven roller assembly (108R) of the leaf strip feeding device (108A);
feeding each leaf strip (12, 14L, 14R) to an abrasive belt (108BB) of a leaf strip scraping device (108B) by the roller (108DSR) of the driving roller assembly (108D) and the roller (108RR) of the driven roller assembly (108R) of the leaf strip feeding device (108A); and
scraping by, the abrasive belt (108BB), the portion of the abaxial portion of each leaf strip (12, 14L, 14R) when a shaft (108BFX) of a first roller assembly (108BFR) is driven by a driving unit (108BM) of the leaf strip scraping device (108B), where the abrasive belt (108BB) is provided on a roller (108BFY) of the first roller assembly (108BFR) and a roller (108BSY) of a second roller assembly (108BSR).

24. The method (200) as claimed in claim 19, wherein said rolling the leaf strip onto the elongated fixture member (R) to facilitate formation of elongated rolled member (12R) by at least one of,
manually rolling the leaf strip (12) onto the elongated fixture member (R) to facilitate formation of elongated rolled member (12R); and
rolling, by a leaf strip spiral rolling device (110A), the leaf strip (12) onto the elongated fixture member (R) to facilitate formation of elongated rolled member (12R), wherein rolling the leaf strip (12) onto the elongated fixture member (R) by the leaf strip spiral rolling device (110A) includes,
engaging one end of the elongated fixture member (R) to a live center (110ATC) of a tailstock assembly (110AT) and engaging another end of the elongated fixture member (R) to an output shaft of a driving unit (110AM) of the leaf strip spiral rolling device (110A);
feeding one end of leaf strip (12) onto the elongated fixture member (R);
blowing hot air onto the leaf strip (12) by a hot air blowing device;
rotating the elongated fixture member (R) by the driving unit (110AM) to facilitate formation of elongated rolled member (12R); and
retaining the elongated rolled member (12R) in a spiral rolled position by at least one of engaging holding members on both ends of the elongated rolled member (12R) and applying a bonding agent on at least a portion of the leaf strip (12); and
removing the elongated fixture member (R) from the live center (110ATC) of the tail stock assembly (110AT) and the output shaft of the driving unit (110AM).

25. The method (200) as claimed in claim 19, wherein applying a bonding agent on at least one of a scraped abaxial portion of at least one add-on leaf strip (14L, 14R) and the scraped abaxial portion of the elongated rolled member (12R) by at least one of,
manually applying a bonding agent on at least one of a scraped abaxial portion of at least one add-on leaf strip (14L, 14R) and the scraped abaxial portion of the elongated rolled member (12R); and
applying by, an add-on leaf strip attaching system (112), a bonding agent on at least one of a scraped abaxial portion of at least one add-on leaf strip (14L, 14R) and the scraped abaxial portion of the elongated rolled member (12R), wherein applying the bonding agent by the add-on leaf strip attaching system (112), includes,
feeding by, an add-on leaf strip spooling device (112A), the add-on leaf strip (14L, 14R) to a bonding agent applying device (112B);
applying by, a roller (112BR) of the bonding agent applying device (112B), bonding agent to the scraped abaxial portion of the add-on leaf strip (14L, 14R), where the roller (112BR) is provided in a tank (112BT) which stores the bonding agent;
feeding by, a roller (112CR) of an add-on leaf strip feeding device (112C), the add-on leaf strip (14L, 14R) from the bonding agent applying device (112B) to an add-on leaf strip cutting device (112D);
blowing hot air to the add-on leaf strip (14L, 14R) by a hot air blowing device; and
cutting by, the add-on leaf strip cutting device (112D), the add-on leaf strip (14L, 14R) of required length from the spool add-on leaf strip.

26. The method (200) as claimed in claim 19, wherein said attaching the abaxial portion of at least one add-on leaf strip (14L, 14R) onto abaxial portion of the elongated rolled member (12R) to facilitate formation of the multilayered bio-degradable food handling device (10) by at least one of,
manually attaching the add-on leaf strip (14L, 14R) on the elongated rolled member (12R) to facilitate formation of the multilayered bio-degradable food handling device (10); and
attaching by, an add-on leaf strip attaching device (112E), the abaxial portion of at least one add-on leaf strip (14L, 14R) onto abaxial portion of the elongated rolled member (12R) to facilitate formation of the multilayered bio-degradable food handling device (10), wherein attaching the add-on leaf strip onto the elongated rolled member (R) by the add-on leaf strip attaching device (112E) includes,
placing the adaxial portion of the add-on leaf strip (14L, 14R) on and in between a fixed roller (fixed roller (112ER) and a spring loaded roller (112ERS) of the add-on leaf strip attaching device (112E) such that the bonding agent applied on the abaxial portion of the add-on leaf strip (14L, 14R) is facing upwards; and
attaching, by the fixed roller (112ER) and the spring loaded roller (112ERS), the add-on leaf strip (14L, 14R) onto the elongated rolled member (R) thereby facilitating formation of the multilayered bio-degradable food handling device (10) by pressing the elongated rolled member (12R) along with the elongated fixture member (R) on the add-on leaf strip (14L, 14R) against said roller (112ER) and said spring loaded roller (112ERS).

27. A bio-degradable food handing device (60) comprising:
a leaf strip (62) having an adaxial portion (62X) and an abaxial portion (62Y), where the abaxial portion (62Y) of said leaf strip (62) is scraped; and
a bonding agent is applied on at least a longitudinal edge portion of the scraped abaxial portion (62Y) of said leaf strip (62),
wherein
said leaf strip (62) is adapted to be rolled on an elongated fixture member (R) to facilitate formation of said bio-degradable food handing device (60); and
the longitudinal edge portion of the scraped abaxial portion (62Y) is attached onto corresponding portion of the adaxial portion (62X) of said leaf strip (62) during rolling of said leaf strip (62) onto the elongated fixture member (R) thereby facilitating formation of said bio-degradable food handing device (60);
said bio-degradable food handing device (60) is a single layered bio-degradable food handing device (60); and
said bio-degradable food handing device (60) is configured for use as at least one of a drinking straw, a stirrer, a chopstick, a balloon stick and a candy stick.

28. A system for making a single layered bio-degradable food handling device (60), said system comprising:
a leaf strip spiral rolling device (110A) comprising,
a driving unit (110AM); and
a tail stock assembly (110AT) opposite to said driving unit (110AM), where said tail stock assembly (110AT) comprises a tail stock (110ATT), a live center holder (110ATH) adapted to be loaded to said tail stock (110ATT) through a spring (110ATS) and a live center (110ATC), where said live center (110ATC) is freely mounted onto said live center holder (110ATH),
wherein
one end of an elongated fixture member (R) is coupled to an output shaft of said driving unit (110AM) and another end of the elongated fixture member (R) is engaged with said live center (110ATC) of said tail stock assembly (110AT);
a bonding agent is applied on at least a longitudinal edge portion of a scraped abaxial portion (62Y) of a leaf strip (62);
one end of the leaf strip (62) is engaged to the elongated fixture member (R);
said driving unit (110AM) is adapted to rotate the elongated fixture member (R) to spiral roll the leaf strip (62) onto the elongated fixture member (R) thereby facilitating formation of the bio-degradable food handing device (60); and
the longitudinal edge portion of the scraped abaxial portion (62Y) attaches onto corresponding portion of the adaxial portion (62X) of the leaf strip (62) during rolling of the leaf strip (62) onto the elongated fixture member (R) thereby maintaining the bio-degradable food handing device (60) in a rolled position.

29. The system as claimed in claim 28, wherein said system comprises,
a leaf strip width cutting system (106) comprises, a driving roller assembly (106D) comprising a shaft (106DS), a plurality of cutting elements (106DC), a plurality of spacers (106DSR) and a driving gear, a driving unit (106M) adapted to drive said shaft (106DS) of said driving roller assembly (106D), a driven roller assembly (106R) comprising a shaft (106RT), a roller (106RR) and a driven gear, where said driven gear is driven by said driving gear of said driving roller assembly (106D) and a leaf strip guiding unit (106G), said guiding unit (106G) is adapted to guide the leaf strips in between said spacers (106DSR) of said driving roller assembly (106D) and said roller (106RR) of said driven roller assembly (106R), wherein said plurality of spacers (106DSR) and said roller (106RR) are adapted to feed the lead strip to at least one said cutting element (106DC), and at least one said cutting element (106DC) is adapted to cut a portion of the leaf strip along a longitudinal direction of the leaf strip to obtain the leaf strip with a predefined width;
a leaf strip scraping system (108) comprises a leaf strip feeding device (108A), a leaf strip scraping device (108B) and a leaf strip scraping setting device (108BGS), wherein said leaf strip feeding device (108A) comprises, a driving roller assembly (108D) comprising a shaft (108DS), a roller (108DSR) and a driving gear, a driving unit (108M) adapted to drive said shaft (108DS) of said driving roller assembly (108D, a driven roller assembly (108R), where said driven roller assembly (108R) comprises a shaft, a roller (108RR) and a driven gear adapted to be driven by said driving gear of said driving roller assembly (108D), a leaf strip guiding unit (108G), said guiding unit (108G) is adapted to guide the leaf strips in between said roller (108DSR) of said driving roller assembly (108D) and said roller (108RR) of said driven roller assembly (108R), wherein said leaf strip scraping device (108B) comprises a first roller assembly (108BFR) comprising a shaft (108BFX) and a roller (108BFY), a second roller assembly (108BSR), where said second roller assembly (108BSR) comprises a shaft and a roller (108BSY), an abrasive belt (108BB), said abrasive belt (108BB) adapted to be provided onto said rollers (108BFY, 108BSY) of said first and second roller assemblies (108BFR, 108BSR) and a driving unit (108BM), said driving unit (108BM) is adapted to drive said shaft (108BFX) of said first roller assembly (108BFR), wherein said rollers (108DSR, 108RR) of said driving and driven roller assemblies (108D, 108R) of said leaf strip feeding device (108A) are adapted to feed the leaf strips to said abrasive belt (108BB), where said abrasive belt (108BB) is adapted to scrape an abaxial portion of the leaf strip (62), and said leaf strip scraping setting device (108BGS) is adapted to guide the leaf strip onto said abrasive belt (108BB) and set amount of scraping on the leaf strip;
a leaf strip spooling device adapted to feed the leaf strip to the elongated fixture member (R), where said leaf strip spooling device comprises a spool member adapted to hold the spool leaf strips;
a leaf strip guiding device (110B) adapted to guide and move the leaf strip spooling device with respect to the rotation of the elongated fixture member (R) by said driving unit (110AM) of said leaf strip spiral rolling device (110A), where said leaf strip guiding device (110B) comprises a guiding member (110BG) and a movable member (110BS), where said movable member (110BS) is movably connected to said guiding member (110BG), where said movable member (110BS) is adapted to mount said leaf strip spooling device; and
a hot air blower device adapted to blow hot air to the leaf strip when the leaf strip is feed to the elongated fixture member (R) to retain bio-degradable food handing device (60) on the elongated fixture member (R) in a rolled position wherein
the bio-degradable food handing device (60) is configured for use as at least one of a drinking straw, a stirrer, a chopstick, a balloon stick and a candy stick; and
the leaf strip is made from at least one of a plant leaf and a tree leaf, where the tree leaf is a coconut tree leaf.

30. A method (300) of making a single layered bio-degradable food handling device (60), said method (300) comprising:
scraping a portion of an abaxial portion (62Y) of a leaf strip (62) along a lengthwise direction of the leaf strip (62);
applying a bonding agent on at least a longitudinal edge portion of the scraped abaxial portion (62Y) of the leaf strip (62); and
rolling the leaf strip (62) onto an elongated fixture member (R) to facilitate formation of the bio-degradable food handling device (60),
wherein
the longitudinal edge portion of the scraped abaxial portion (62Y) attaches onto corresponding portion of the adaxial portion (62X) of the leaf strip (62) during rolling of the leaf strip (62) onto the elongated fixture member (R) thereby maintaining the bio-degradable food handing device (60) in a rolled position.
